(19) United States
(12) Patent Application Publication
(10) Pub. No.: US 2011/0206204 A1
(43) Pub. Date: Aug. 25, 2011

(54) METHODS AND DEVICES OF QUANTUM ENCODING ON DWDM (ROADM) NETWORK AND FIBER OPTIC LINKS .

(76) Inventor: Dmitry Ivanovich Sychev, Balashiha (RU)

(21) Appl. No.: 13/124,425

(22) PCT Filed: Oct. 16, 2009
(86) PCT No.: PCT/RU2009/000552

§ 371 Date: Apr. 15, 2011

Related U.S. Application Data
(60) Provisional application No. 61/106,171, filed on Oct. 17, 2008.

(51) Int. Cl. H04L 9/00

(52) U.S. Cl. 380/256

(57) ABSTRACT

The invention solves the following complicated problems. Elaboration of the procedure for secret key extraction from the lower layer optic signal even in a presence of noise in fiber-optic cable. The realization of the quantum protection amplification scheme to clean states of the entangling polarized photons against noise in optical channels, especially in case of use Einstein-Podolsky-Rozen method with single photon source for transmitting and measuring secret keys photon polarization in ROADM network. The development of a system for code key transmission that satisfies requirements of fortuitousness and privacy along with speed enlargement of the key generation in ROADM network. The achievement of the acceptable optical fiber amplification without losing its behavior and the protocol determination, which will allow to detect and correct bit errors in fiber optic cable and ROADM network, caused by linear and nonlinear effects. The development of quantum encoding systems for telecommunication topologies.

### BACKGROUND OF INVENTION

Prior Art

The invention relates to data transmission via fiber optical lines and particularly to methods and devices of data encoding therefore.

In Europe in October, 2008 the commercial network in which the quantum technology of enciphering of data was used was shown for the first time. The technology of quantum cryptography provides unprecedented for today a level of enciphering of data. It took them 4 years to develop the network, and 12 European countries took part in the project. The network, constructed by companies SECOQC and Siemens, included 6 units located in Vienna, the capital of Austria, and in Saint Pelten, located nearby. The distance between the units was from 6 up to 82 km. In the project 8 communication lines were used—7 of them were made of fiber-optical cables, of 200 km in the general extent, and one of the communications was carried out by air. In each unit there was a small block, in size of a desktop computer; each block was equipped by light gauges. Elementary particles transferred on communication channels, photons, were carriers of the information, and of codes of enciphering at the same time.

Einstein-Podolsky-Rozen paradox (EPR) and Jon Bell's theorem (1964) have served the conceptual foundation for quantum encoding. Quantum encoding is based on the entanglement of the pair of pure single-photon impulses, the source for which is a depressed laser ray. Henceforth the theorem by Jon Bell was extended by J. F. Clauser and M. A. Horne (1974), which made it possible to check experimentally the foundation of quantum encoding. The result surpassed all expectations—quantum encoding can secure the absolute privacy, i.e. ensure data transmission security from unauthorized access (interception and decoding).

The existing standard Data Encryption Standard (DES) uses a short key, consisting of 64 bits, 56 of which are used directly in algorithm, and the last 8 are used for detecting errors. DES enciphers blocks of the plain text of 64 bits in length. Breaking-in DES requires searching among the fifty-sixth power of two possible keys. Even though if a classical computer starts examining them at the speed of one million per second, it will need about 1000 years to find the correct key, whereas the quantum computer, using Love Grovers's algorithm from AT&T Bell labs will do this task less than in four minutes. The same thing concerns the more reliable methods of encryption, such as Rivest-Shamir-Adleman (RSA) algorithm, which are used to protect electronic banking accounts. When a computer for quantum factorization or, to put it in simpler words, for quick decomposition of large numbers, will be designed and it will be able to use the algorithm of factorization of large numbers, discovered by Peter Shore (1991) besides Grover's algorithm, then all the access control systems mentioned above (DES, RSA), will be, to put it mildly, not very reliable. Quite often from time to time a rumor goes round that DES has been already cracked, but even if it is not true, DES can't be considered to be absolutely secure, because it uses one and the same coding key a lot of times. Quantum encoding makes it possible to use so-called a distributed key with polarized photons or phase encoding, which is only used for one communication session.

Nowadays the application of methods of quantum encoding on dense wavelength division multiplexing (DWDM) (Reconfigurable Optical Add Drop Multiplexers (ROADM)) network are of great interest.

ROADM is key elements for building a dynamically reconfigurable DWDM network. ROADM accelerates triple-play service deployment and enables advanced wavelength applications at a much lower cost.

ROADM network consist of next units (FIG. 1):
WXC—Wavelength Cross Connect;
WSS—Wavelength Selective Switch;
EDFA—Erbium Doped Fiber Amplifier;
PLC—Planar Light wave Circuit;
MUX—Multiplexer;
DEMUX—Demultiplexer;
OAM—Optical Amplifier Module (inc. dispersion compensation);
FBG—Fiber Bragg Grating;
Raman amplifier.

The technical result of the proposed invention lays in:
optimization of the existing systems of quantum encoding in order to enlarge the operating range in ROADM and fiber optic,
enlarging the speed of the key generation,
reducing quantum bit-error probability,
construction of a plurality of stable quantum encoding systems for end-users use with various EPR configurations,
procedure elaborating of the secret key extraction from the lower layer optic signal even in a presence of noise in fiber-optic cable,
developing of quantum encoding systems for such widespread telecommunications topologies, as point-to-point, point-to-multipoint, star, ring, adjacent rings.

### SUMMARY OF INVENTION

The proposed methods and devices solves the next complicated problems.

Elaboration of the procedure for extraction of the secret key from the lower layer optic signal even if there is a certain amount of noise in fiber-optic cable. The realization of the quantum protection amplification (QPA) scheme for the purpose to clean states of the entangling polarized photons against noise in optical channels, especially in case if we use Einstein-Podolsky-Rozen (EPR) method with single photon source for transmitting and measuring secret keys photon polarization in ROADM network.

Effect EPR arises when the spherical and symmetric atom starts to radiate two photons in opposite directions towards two observers. Photons are always radiated with uncertain (indefinite) polarization but as they are symmetric, both photons on opposite sides have opposite polarization. Polarization of photons can be defined only after carrying out of measurements. A. Ekert /1/ has offered the scheme of transmission of confidential quantum keys that uses EPR method. The sender generates some EPR pairs of photons. One photon from each pair remains on the transferring side, and the second is dispatched to its partner. In this case, at quality of registration of photons close to 100% if the sender registers logic 1, its partner on an opposite side always registers logic 0 and on the contrary. Thus, both partners can receive identical confidential keys. But practical implementation of this scheme seems to be quite problematic, especially in ROADM network, because of a considerable quantity of intermediate nodes and, accordingly, presence of a considerable quantity of noise at the optical channel against which the estimation of a condition of polarization of photons on the receiving side should be carried out.

The development of a good single-photon laser source. Since it is just a depressed laser ray that serves the source of light for quantum encoding, the number of photons in the impulse is random quantity with Poisson distribution. That means that some impulses might contain no photons at all, whereas the others might contain several of them. Impulses containing more than one photon per impulse should be avoided in order to exclude the probability of leak to an eavesdropper (an intercepting agent). In order to make the probability of more than one photon's presence in one impulse quite low, it is necessary to use very week impulses. This, in turn, can reduce the signal/noise ratio.

The development of such a system for code key transmission that satisfies requirements of fortuitousness and privacy and allows enlarge the speed and the distance of the generation of the key in ROADM network.

The achievement of the acceptable optical fiber amplification without losing its behavior and the determination of the protocol, which will make it possible to detect and correct bit errors in fiber optic cable and ROADM network, caused by linear (attenuation, noise, dispersion) and nonlinear (four wave mixing, self phase modulation, cross phase modulation) effects. Elaboration of the station of reiteration for quantum cryptography (quantum repeater). The existing systems of quantum encoding, that use infra-red photons in quartz light-emitting diode, have a level of loss on the order of 0.2 dB/km. So, apparently, quantum encoding systems at the distance exceeding 100 km (62.14 miles) (with loss in 20 dB and the level of passing-through 0.01) without using systems of recovery, which do not destroy quantum correlation, are impossible.

For high speed data service (40 Gb/s, 100 Gb/s) it is necessary to find out if it is possible to use encoding and modulation of an optic signal for the purpose of compensation polarization mode dispersion (PMD) and chromatic dispersion (CD).

The development of quantum encoding systems for widespread telecommunications topologies, such as point-to-point, point-to-multipoint, star, ring, adjacent rings. and for use in ROADM network. Today, in addition to the topologies point-to-point and point-to-multipoint, (for example, the central office of a bank—its branches), some improvement in that direction has been suggested already, but may be it still needs deeper investigations.

### BRIEF DESCRIPTION OF THE DRAWING

FIG. 1. Structure of ROADM network.

FIG. 2. Diagram showing the difference between conventional out-of-band OSNR and in-band OSNR measurements.

FIG. 3. Diagram showing the power spectrum of DFB laser.

FIG. 4. Diagram showing the power spectrum after DFB laser and optical multiplexer in a presence of noise.

FIG. 5. Diagram showing the power spectrum after ROADM WXC-Wavelength Cross Connect.

FIG. 6. Diagram showing the power spectrum after PLC and EDFA.

FIG. 7. Block diagram of the OPS method.

FIG. 8. Diagram showing the test In-band OSNR for various methods.

FIG. 9. Table showing the comparison of the OSNR measurement methods.

FIG. 10. Block diagram of test setup at Tellabs/Chicago.

FIG. 11. Diagram showing the OSNR Measurement Error at 43 Gb/s.

FIG. 12. Diagram showing the experimental setup data.

FIG. 13. Diagram showing the OSNR measured by OPS-method for different modulation rates without PMD.

FIG. 14. Diagram showing the OSNR measurement error for 43 G signals with OPS-method at DGD up to 20 ps.

FIG. 15. Diagram showing the OSNR measurement error for 10G signals with OPS-method at DGD up to 50 ps.

FIG. 16. Diagram showing the system for the code key passing

FIG. 16.1. Diagram illustrating the Fixed Analyzer Method.

FIG. 16.2. Diagram illustrating the JME Method.

FIG. 16.3. Diagram illustrating the TINTY Method.

FIG. 16.4. Diagram illustrating the GINTY Method.

FIG. 17. Diagram showing the way of simplification of optical network construction using eDCO and ROADM.

FIG. 18. Diagram showing the G.709 OTN Overhead.

FIG. 19. Diagram showing the Reed Solomon code ITU-T G.975 recommendation for the scheme FEC G.709.

FIG. 20. Diagram showing the Reed Solomon (RS (255,239)) code algorithm.

FIG. 21. Diagram showing the Bit Error Rate Performance on different algorithm FEC.

FIG. 22. Table showing the comparative description of different types of modulations.

FIG. 23. Diagram showing the type of modulation, that allow to solve of the problems on compensation of dispersion losses.

### DETAILED DESCRIPTION OF THE INVENTION

Relying on the above said it can be assumed that quantum cryptography methods known in the art are completely realizable from the technical viewpoint in ROADM network.

Hereinafter the following solution of abovementioned problems is proposed.

1. The private key extraction procedure in the presence of noise in fiber optics and ROADM networks for EPR method with single photon source for transmitting and measuring of photons polarization.

The realization of the QPA scheme for the purpose to clean states of the entangling polarized photons in the presence of noise in optical channels ROADM based network

The principles, which will be examined in point 4 (use of the protocols, which will make it possible to detect and correct bit errors in fiber optic cable, caused by linear and nonlinear effects) and, which make it possible to reach the acceptable quantum channel amplification without losing its behavior, they in any way assume that some amount of noise is still left. That means that at the reception we have a number of so called unclean entangled states of polarized photons, which have appeared in the result of various linear and non-linear anomalies in the optical channel, especially in case if we use EPR method with single photon source for transmitting and measuring of polarization in ROADM network.

Effect EPR arises when the spherical and symmetric atom starts to radiate two photons in opposite directions towards two observers. Photons are always radiated with uncertain polarization but as they are symmetric, both photons on opposite sides have opposite polarization. Polarization of photons can be defined only after carrying out of measurements. A. Ekert has offered the scheme of transmission of confidential quantum keys that uses EPR method. The sender generates some EPR pairs of photons. One photon from each pair remains on the transferring side, and the second is dispatched to its partner. In this case, at quality of registration of photons close to 100% if the sender registers logic 1, its partner on an opposite side always registers logic 0 and on the contrary. Thus, both partners can receive identical confidential keys. But practical implementation of this scheme seems to be quite problematic, especially in ROADM network, because of a considerable quantity of intermediate nodes and, accordingly, presence of a considerable quantity of noise at the optical channel against which the estimation of a condition of polarization photons on the receiving side should be carried out.

An Optical Polarized Splitter (OPS) method is proposed to resolve these drawbacks. There are a lot of schemes of purifying of the entangled photons, but the QPA scheme (quantum secrecy amplification) is considered to be the most effective among them. It was set forth in the work /1/. It was proved, that this kind of scheme causes higher security of quantum cryptography, which uses noisy communication channels. The evidence was received in 1998 and it was set forth in the work /2/.

The matter of the evidence comes to the following. If we start purifying the entanglement with those photon couples, which quality exceeds 50%, and then the couples' state after the purifying procedure (which consists of several iterations or steps) always comes to pure state of the photon couples with nearly 100% probability. At the same time a certain procedure is carried out that allows it to detect potential eavesdropping. The estimation of the amount of the information, which could have become open to the eavesdropping agent, can be regarded as the function of characteristic (data) with acceptable, tolerable or intolerable quality. By “acceptable” it is implied that, by means of certain successive procedures, such as quantum amplification of secrecy, it is possible to reduce quality up to any acceptable level at the expense of using a shorter key. However, it is necessary to keep in mind a certain threshold at which too much information has leaked to the eavesdropping agent. In this case no other further quantum amplification of secrecy is impossible and this communication session should be stopped.

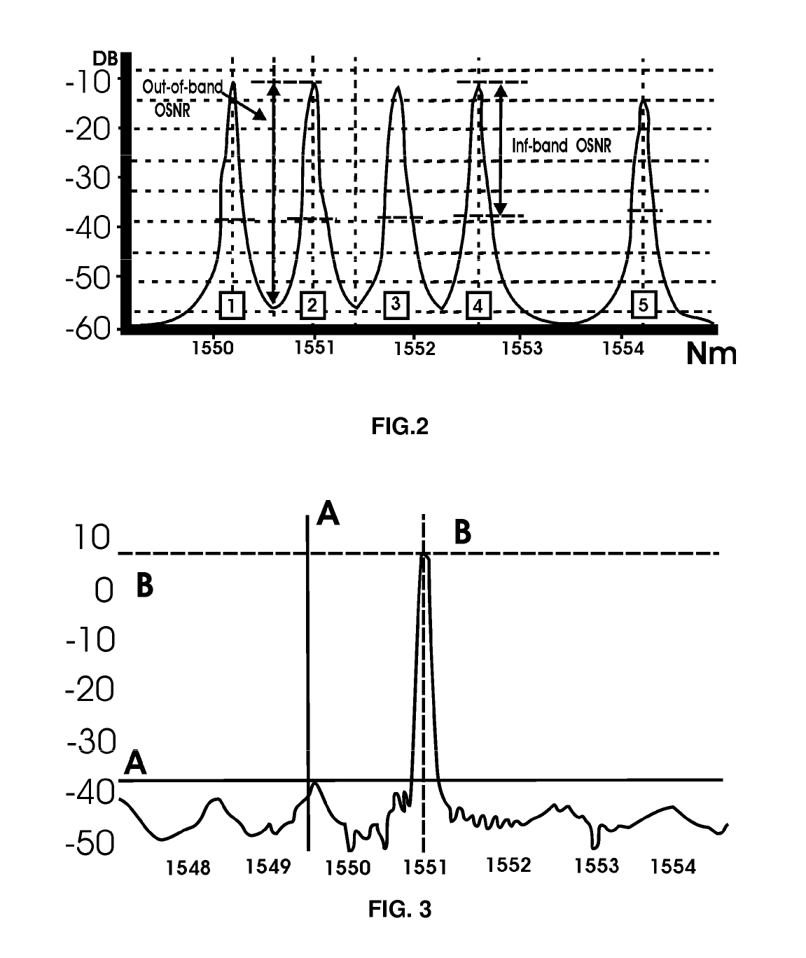

The OPS method may consider as suitable for measuring the in-band Optical Signal-to-Noise Ratio (OSNR) as one of the cases of practical realization of QPA method. The OSNR is the key performance parameter in optical networks that predicts the bit error rate (BER) of the system. OSNR is conventionally obtained by measuring the total signal power in the channel passband and the amplified spontaneous emission (ASE) noise levels in the gaps between the optical channels. This is called the out-of-band OSNR. In transparent reconfigurable wavelength division multiplexing (WDM) networks, the ASE noise floor undergoes a noise shaping by the in-line optical filters of the ROADMs suppressing the noise between optical channels. The out-of-band OSNR will overestimate the ‘true’ OSNR. By measuring the noise power inside the optical channel passband it is possible to obtain the ‘true’ OSNR which is called the in-band OSNR, see FIG. 2.

To get access to the in-band noise level several methods using the polarization-nulling technique have been proposed. The polarization-nulling technique is considered sensitive to polarization mode dispersion (PMD) effects, especially in high speed networks. /3/

Farther a new technique will be demonstrated. It serves to overcome the PMD sensitivity based on polarization splitting and simultaneous measurement of both states of polarization (SOP) with a dual port Optical Spectrum Analyzer (OSA). This method is called the optical polarization splitting method (OPS).

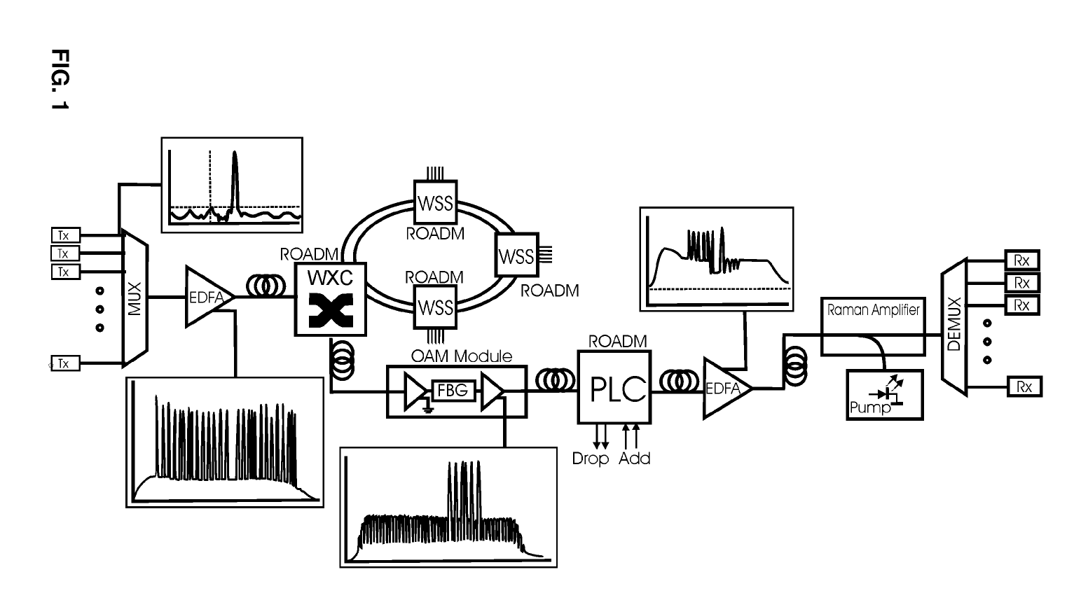

In contrast to linear interpolation OSNR method, which carries out measuring of out-of-band OSNR, in-band OSNR also allows it to estimate the value of “pure” noise proper. While examining optical signal spectrum, step by step passing through compound ROADM devices (FIG. 1.), one can notice, that so called the noise arm increases in proportion to the number of devices, which the optical signal passes through from Distributed Feedback Laser (DFB) to the last Add/Drop optical multiplexer and Erbium Doped Fiber Amplifier EDFA following it in the transport network ROADM.

FIG. 3 shows the diagram of signal after DFB laser. And the noise-level proper is fluctuating at the mark 40 dB—the line A. The signal level approximately equals 8 dB—the line B.

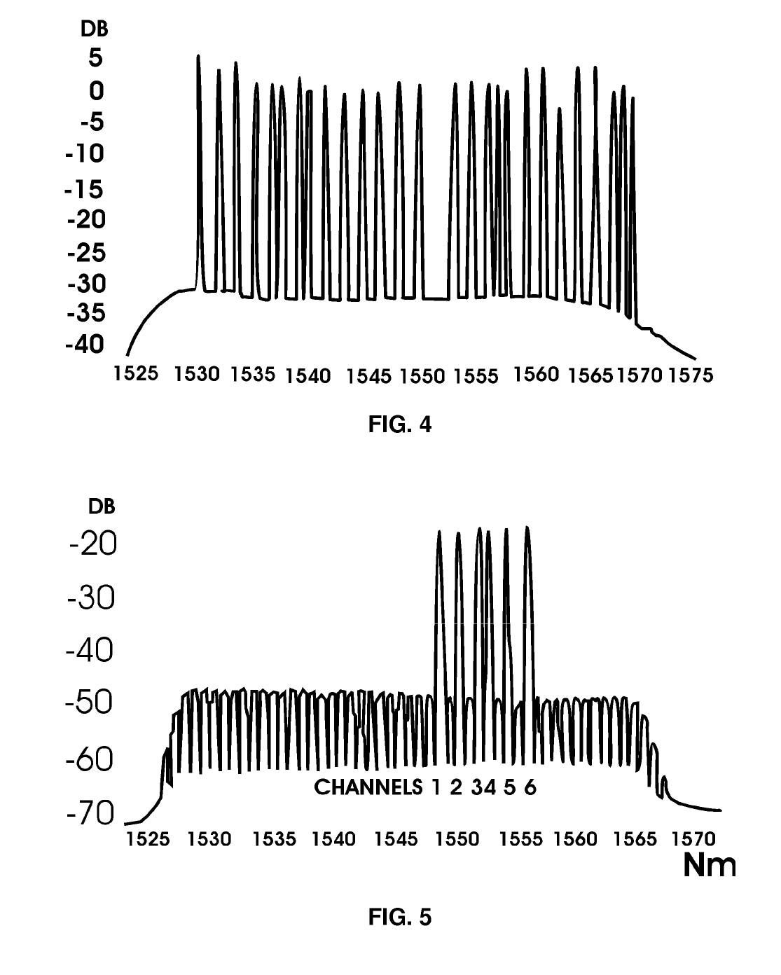

FIG. 4. shows the result of work of the first optical multiplexer (MUX) FIG. 1.), which has united 27 signals, and the next after it is Erbium Doped Fiber Amplifier (EDFA) (FIG. 1.). The noise-level goes up to approximately −32 dB. The arm of pure noise increases. The signal level has fallen up to 2-3 dB.

FIG. 5 shows a spectrogram, received after the optical cross connector Wavelength Cross Connect (WXC)—1.), which has dropped six channels and after following it Optical Amplifier Module (OAM FIG. 1.) with an embedded Fiber Bragg grating (FBG), which is used for CD compensation. In the result of that the arm of pure signal with respect to pure noise has fallen. OSNR keeps on falling.

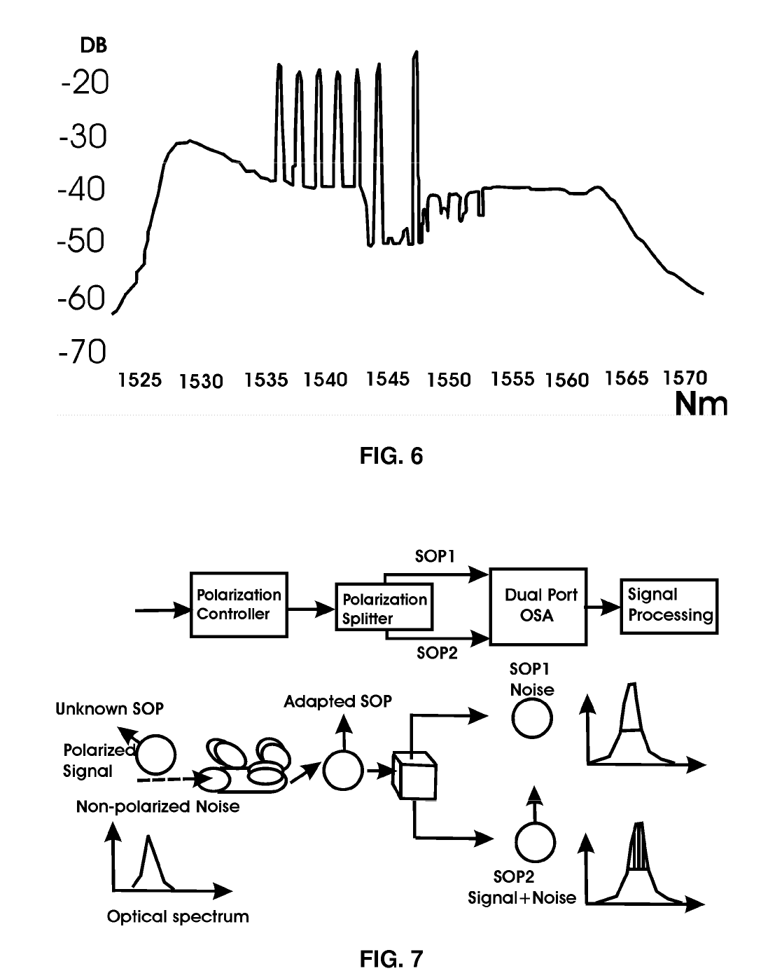

The next optical signal conditioning into Planar Light Wave Circuit (PLC, see FIG. 1.) with the following amplification in EDFA caused the situation, when the signal/noise ratio can be evaluated as rather unsatisfactory, specifically the signal value is fluctuating near the mark −17 dB, and the arm of the pure noise proper increases up to −32 dB.(FIG. 6.) The foremost cause of this effect is that each optical signal amplifier in ROADM introduces so called ASE noise, which worsens the value of OSNR. It is obvious that it causes the necessity of testing of in-band OSNR.

Thus, in order to estimate the amount of “pure” noise, brought by the components of ROADM network and/or by switching on probable optical passive and active elements of the eavesdropping agent, it is possible to use the method of OPS, applicable for in-band OSNR measuring.

The essence of this method is shown further. The underlying concept of the polarization-nulling technique is that the modulated signals consist of arbitrary polarized light, while the ASE noise consists of non-polarized light (FIG. 7) shows the operating principle of the proposed OPS method.

An adjustable PC is used to find the minimum and the maximum optical power by aligning to the state of polarization of the signal or its orthogonal state to the polarizer. It is possible to suppress the polarized optical signal (PS) and get access to the non-polarized in-band noise (PN). A high performance polarization beam splitter (PBS) is used to split the signal into two arms, SOP-1 (states of polarization) and SOP-2, both being linearly polarized in orthogonal states. The dual port high resolution OSA can simultaneously measure both arms (SOP-1 and SOP-2) of the PBS containing the suppressed signal (PS1, PS2) and the ASE noise. A measurement of the in-band OSNR will need multiple scans over a selected wavelength range with different settings of the PC to find the maximum suppression of the signal. The minimum of P1 and P2 indicates PN, with the signal being suppressed, whereas the sum of P1 and P2 shows PS+PN. At the end of the measurement the in-band OSNR values of all channels are shown based on the following equations:

P1=(PS1+.PN) (1)

P2=(PS2+.PN) (2)

PS=PS1+PS2 (3)

P1+P2=PS+PN (4)

PN=Min (P1, P2) (5)

OSNR=PS/PN=(P1+P2)−Min(P1,P2))/Min(P1,P2) (6)

Under the influence of PMD, the signal will depolarize with a frequency-dependent SOP, causing a noise power overestimation and signal power under-estimation due to the linear polarizer aligned with a single SOP. Optical polarization splitting method (OPS-method) shows high PMD robustness due to three factors:

1. Both SOP are simultaneously measured avoiding any underestimation of the total aggregate power of the signal and the ASE.

2. An ultra narrow-band filter, with 7.5 GHz bandwidth, is used to minimize depolarization effects.

3. An adaptive off-center measurement is employed to measure the noise level at the optical signal slope, reducing the effect of overestimating the ASE noise. With the combination of a wavelength scanning spectrum analyzer and the alignment of the SOP by the adjustable polarization controller, it is possible to measure the in-band OSNR of all optical channels of a DWDM network with reduced sensitivity to PMD.

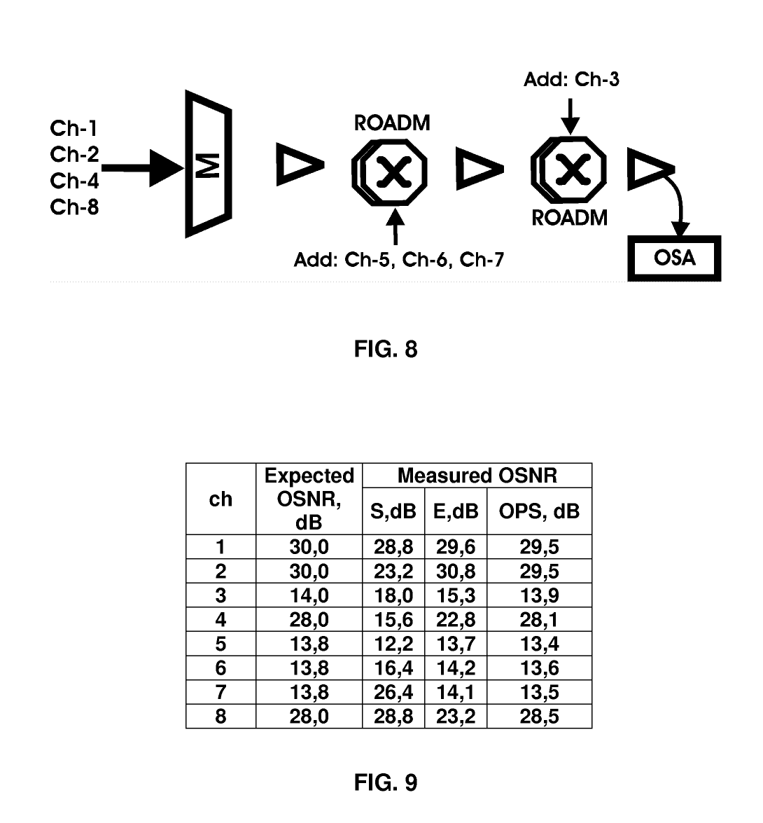

To compare the accuracy of OSNR measurement data by means of various methods, see the following chart of measurement (FIG. 8), that shows the result of measuring OSNR by different methods for the eight channels of ROADM. It was made in the laboratory Tellabs Chicago US /4/.

S—is the out-of-band OSNR method, which has given five false (incorrect) measurement data. (2, 3, 4, 6, 7 ch—FIG. 9.)

E—is the polarization diversity detection method, which has given three incorrect results. (3, 4, 8 ch—FIG. 9) The only difference between this method and OPS is that it (polarization diversity detection) does not use the polarization controller.

OPS—is the method, which has shown the most correct results. (FIG. 9).

Experiments and results for the OPS method estimation.

Most studies and experiments of polarization-nulling based on OSNR measurements have been focused on 2.5 Gb/s and 10 Gb/s NRZ and 43 Gb/s CS-RZ, PSBT and DPSK-RZ signals. Further are shown the results of OSNR measurements using the OPS method in Tellabs Chicago US ultra high speed agile optical networks that include different optical filter technologies and 40 Gb/s transponder modules with different modulations (see below).

The sensitivity of the OPS-method against the following effects has been tested.
PMD ;
Filter cascading (1, 4, 8, 15 optical filters);
Modulation format (CS-RZ, PSBT, DPSK-RZ) ;
Modulation speed (43 G and 10.7 G).

Test Setup:

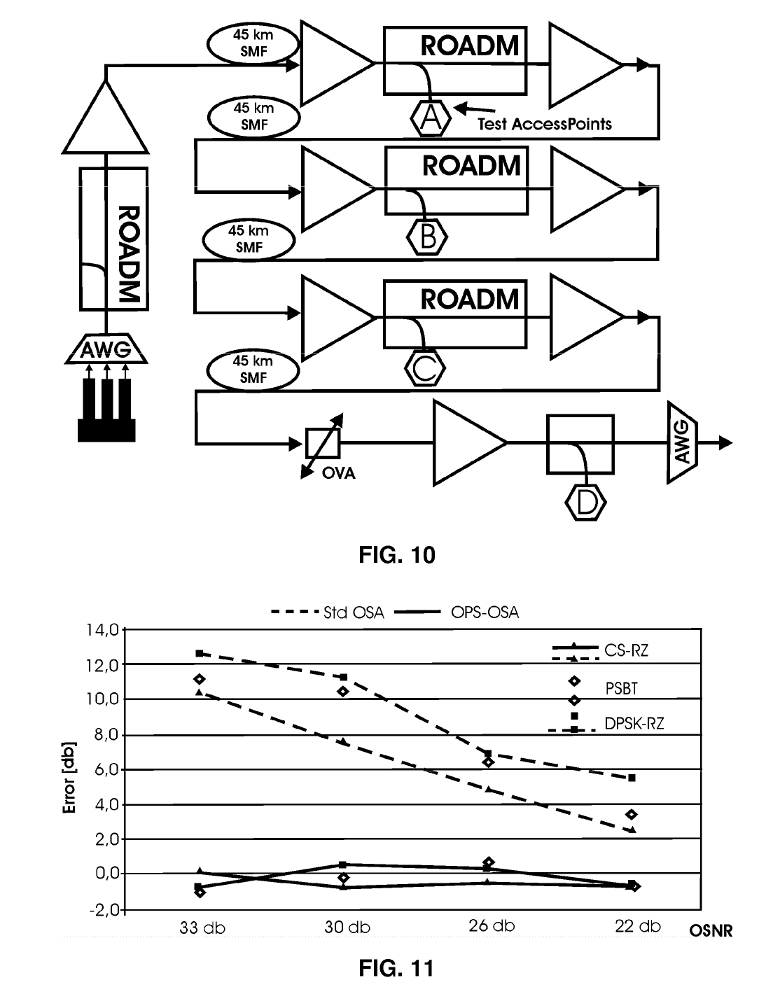

The following pictures (FIG. 10) show the block diagram and the test setup at Tellabs in Chicago:
180 km SSMF with 8 optical amplifiers and 4 ROADMs
3 optical channels at 43 Gb/s: CS-RZ, PSBT and DPSK-RZ.

Test Results
The OSNR was measured with a standard optical spectrum analyzer using the linear interpolation method and a new OSA using the OPS method. The measurement results at the test access points A to D (FIG. 10) representing an OSNR range from 33 dB to 22 dB are shown in the following table (FIG. 11).

The test results show that the conventional OSA method will always show OSNR values that are too high since this method is based on the noise power in the gaps between the channels. This is suppressed by in-line optical filtering. The error can be as high as 9-10 dB depending on the system configuration. The OPS-OSA method shows very accurate measurements with an error of less than ±1 dB.

An improved OSNR measurement technique called Optical Polarization Splitting based on the polarization-nulling method is proposed. The test results with Tellabs ultra high speed networks showed that the proposed technique could measure the OSNR accurately at all modulation formats even when the signal was significantly depolarized due to PMD and nonlinear birefringence.

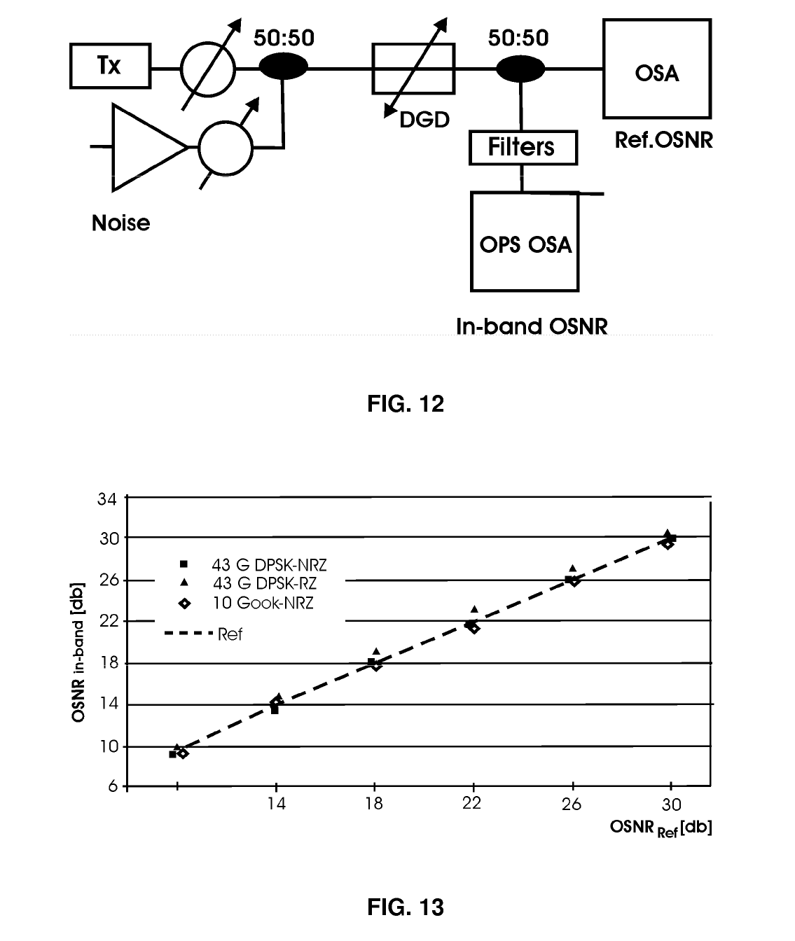

FIG. 12 shows the experimental setup using different signal sources (Tx) with 10 G NRZ, 43 G-NRZ-DPSK, 43 G-RZ-DPSK and 43 G-PSBT modulation.

The OSNR could be adjusted between 10 dB and 30 dB, using two attenuators and a 3 dB coupler combining an ASE noise source and the modulated signal. A PMD emulator was inserted to simulate the effects of differential group delay (DGD) in the range of 0 to 50 ps. To simulate the effect of a ROADM network, an optical filter bank was inserted (Filters). The 0.5 dB filter bandwidth could be modified between 32 GHz and 23 GHz to emulate the bandwidth narrowing effect due to filter cascading of 11 and 22 ROADMs. As a reference value, the OSNR was measured with a standard OSA with a 3 dB coupler in parallel to the ROADM filters.

FIG. 13 shows the measurement result of the proposed OPS-method for different modulation schemes without PMD. The measurement error was smaller than 0.5 dB for OSNR varying from 10 dB to 30 dB.

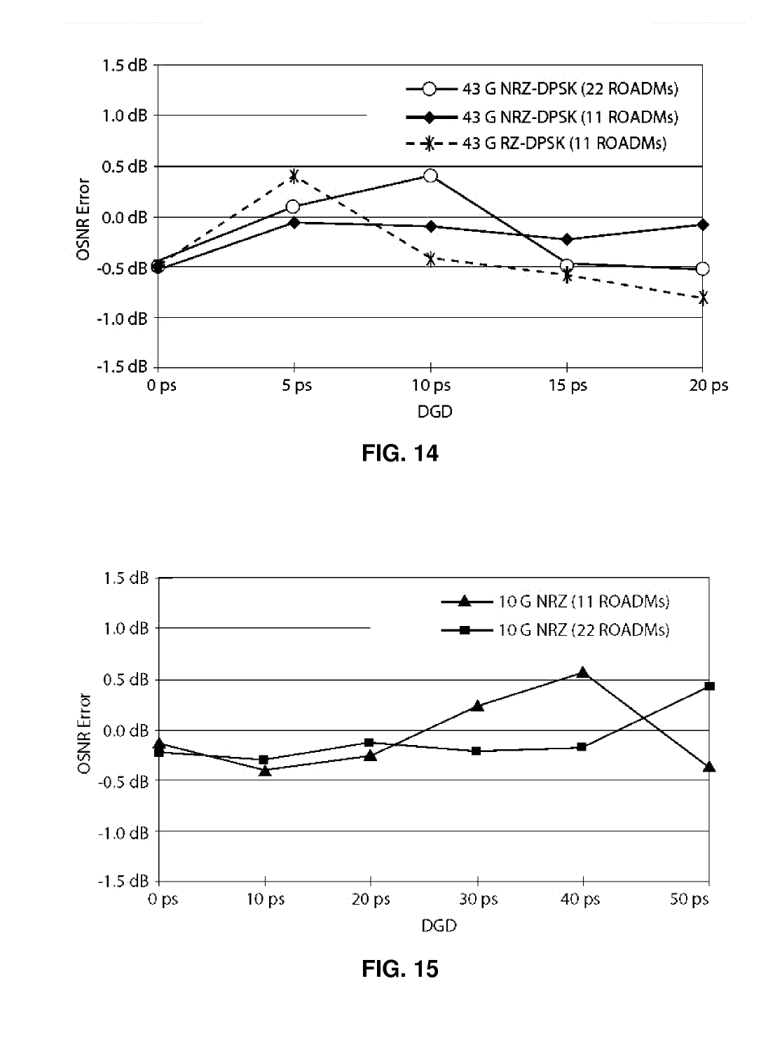

FIG. 14 shows the measurement accuracy of 43 G signals with DGD in the range of 0 to 20 ps. The measurement accuracy for the 43 G-NRZ signals was in the range of 0.5 dB.

The next FIG. 15 shows the measurement results of the OPS method for 10 G signals with DGD up to 50 ps. The measurement accuracy was in the range of 0.5 dB.

The OPS method combines the advantage of a conventional high resolution OSA and the improved polarization-nulling technique with polarization splitting for ‘true’ in-band OSNR measurement. Using simultaneous measurement of both SOP, together with adaptive narrow band off-center filtering gives high robustness to PMD effects. Measurements at data rates up to 43 G have shown an accuracy of 0.5 dB. A further advantage of the OPS method is that all WDM channels can be measured simultaneously and it imposes no constraints on measurements in high-speed communication systems 40 Gb/s and 100 Gb/s.

Thus, the OPS method is the best for in-band OSNR measuring use, as one of the cases of practical realizations of the QPA. OPS method will allow it to start purifying of entanglement from those photon couples whose quality is not lower than 50%, especially in case of use EPR method with single photon source for transmit and measure secret keys photon polarization in ROADM network.

2. The product of the Canadian company EXFO Electro-Optical Engineering Inc WDM Laser Source IQS-2400 is up to date one of the best, might be use like single-photon laser source for code key shipment in ROADM network.

EXFO has a certificate ISO 9001 and the quality certificate for this type of equipment. Besides, IQS-2400 conforms to “Part 15 of the FCC Rules” and European Union WEEE directive.

The following main principals are observed:
the device cannot be the source of parasitic interference;
the device treats any type of input interference, including those, which may cause objectionable jobs.

Hereinafter the necessary main technical characteristics are introduced:
C, L wave bands C-band 1528 nm to 1565 nm, L-band 1566 nm to 1606 nm;
+13 dBm power output;
±0.01 nm accuracy (fidelity) and high retention stability for specified wave length during 8 hours at 23° C.±1° C. and relative humidity 50%, that allows it to suppress depolarization and at random fluctuating birefringence (Hi-Bi). The given accuracy is the best among all possible at present.
High-precision WDM Laser Source;
IQS-2400 WDM Laser Source allows it to do stable power testing of high-accuracy—Power stability c, d (dB) 15 min ±0.005 (Δ=0.01) 8 h±0.03 (Δ=0.06), Output power uncertainty c (dB) ±0.3, of spectral sensitivity—Wavelength accuracy c, d (nm) ±0.01 Wavelength stability d, e(nm) ±0.002 of active and passive components, and WDM blocks;
IQS-2400 emulates ITU-T in lambda beds (channels or canals) in WDM applications, such as multiwave net simulation and multiplex gangway ports for testing EDFA amplifiers' characteristics and for testing losses in the passive DWDM components (elements);
IQS-2400 makes it possible to test all kinds of recommended ITU-T wavelengths for DWDM with (noise) dithering up to 300 kHz with a square and triangular pulse shape. Herewith the output power amounts to 13 dBm, in discrete steps of 10 dB;
DFB (Distributed Feedback Laser) diode can be made with characteristics required for customer's tests for both standard fiber optic cables and PMF (Polarization Maintaining Fiber).

Laser irradiation parameters of IQS-2400 WDM Laser Source:

1.1. The regular (standard) mode of behavior provides testing at any wavelength, making it possible to control the output power at both manual and automatic mode.

1.2. High-accuracy wave stability mode provides wavelength retention of the wavelength and of the output power via adjustment (control) of the laser temperature and the power with the step of 0.01 C (Celsius) and 0.01 mA accordingly. In contrast to the regular mode of behavior, where there may be a slight drift of the central harmonic wave in consideration of dispersion effects, the given method makes it possible to do high accuracy tests for a long time. The temperature stabilization circuit ensures low central wavelength drift.

1.3. The (noise) dithering mode provides the possibility of signal modulation over the range 10 Hz to 300 kHz and makes it possible to input some slight oscillations of square and triangular pulses into CW signal (signal coherence length).

1.4. The mode of pulsations (on/off) provides the possibility of signal modulation over the range 10 Hz to 300 kHz, the maximal optic signal suppression during activation and ensures the external synchronization from several sources, including external TTL and synchronization output of the DWDM modules. The sources of synchronization may be thrown into action (switched on) with different magnitudes of amplitude, phase and frequency.

The automatic calibration of DFB laser must be done in strict accordance with NIST-traceable wavelength meter and four-channel power meter. As a result there is an accurate value (magnitude) of the central impulse of harmonic component at any declared value of the output power.
Laser sources specifications.
IQS-2402 Specifications:
Model P4
Wavelength band (nm) 1308 ±5
Wavelength tuning range (nm) ±0.5 (typical)
Wavelength tuning resolution b (nm) 0.01
Wavelength accuracy c, d (nm) ±0.01
Wavelength stability d, e (nm) ±0.002
Output power f (dBm) 10
Output power attenuation range (dB) >6
Spectral linewidth (MHz) (typical) <20
Sidemode suppression g (dB) 30 (40 typical)
Output power uncertainty c (dB) ±0.3
Power stability c, d (dB) 15 min ±0.005 (Δ=0.01)
8 h ±0.03 (Δ=0.06)
Modulation frequency (internal or external sync.) (kHz) 0.010 to 300
Dithered modulation amplitude range h (mA) 1 to 5
Dithered modulation electrical waveform Square/triangular.
IQS-2403 Specifications:
Model P4/P5 P6/P7
Wavelength band: C-band 1528 nm to1565 nm
Wavelength tuning range a (nm) ±1
Wavelength tuning resolution b (nm) 0.01
Wavelength accuracy c, d (nm) ±0.01±0.02
Wavelength stability d, e (nm) ±0.002±0.002
Output power f (dBm) 10 13
Spectral linewidth (MHz) (typical) <20
Output power attenuation range (dB) 10
Sidemode suppression g (dB) 30 (40 typical)
Output power uncertainty c (dB) ±0.3
Power stability c, d (dB) 15 min ±0.005 (Δ=0.01)
8 h ±0.03 (Δ=0.06) ±0.03 (Δ=0.06)
Modulation frequency (internal or external sync.) (kHz) 0.010 to 300
Dithered modulation amplitude range h (mA) 1 to 5
Dithered modulation electrical waveform Square/triangular
Size (H×W×D) 125 mm×36 mm×282 mm 4 15/16 in×1 7/16 in×11⅛ in
Weight 0.580 kg 1.25 lb
Temperature
Operating 10° C. to 40° C. 50° F. to 104° F.
Storage −40° C. to 70° C. −40° F. to 158° F.
Relative humidity 0 to 95% non-condensing
Instruments Drivers
Lab VIEW™ drivers, SCPI commands and COM/DCOM libraries
Remote Control
With IQS-500: GPIB (IEEE-488.1, IEEE-488.2) Ethernet and RS-232.
Standard Accessories
User guide, test report and Certificate of Compliance.
IQS-2404 Specifications:
Model P4/P5 P6/P7
Wavelength band: L-band 1566 nm to 1606 nm
Wavelength tuning range a (nm) ±1
Wavelength tuning resolution b (nm) 0.01
Wavelength accuracy c, d (nm) ±0.01±0.02
Wavelength stability d, e (nm) ±0.002±0.002
Output power f (dBm) 10 13
Output power attenuation range (dB) 10
Spectral line width (MHz) (typical) <20
Side mode suppression g (dB) 30 (40 typical)
Output power uncertainty c (dB) ±0.3
Power stability c, d (dB) 15 min ±0.005 (Δ=0.01) 8 h±0.03 (Δ=0.06)
Modulation frequency (internal or external sync.) (kHz) 0.010 to 300
Dithered modulation amplitude range h (mA) 1 to 5
Dithered modulation electrical waveform Square/triangular
Note:
a. Guaranteed if the ambient temperature stays between 15° C. to 30° C.
b. In high-wavelength stability mode, better resolution is possible, but on a limited range.
c. Specified at 23° C.±1° C. with 50% relative humidity.
d. After a 1-hour warm up period.
e. For 8 hours at 23° C.±1° C. with 50% relative humidity.
f. Output power is specified at connector output.
g. Guaranteed at maximum power level.
h. Dithered modulation is only available internally at a typical duty cycle of 50% duty cycle.

### General Specifications:

Wavelength band Connector code
02=1308 nm 96=E-2000/APCa
03=1528-1565 nm C-band EA-EUI-89=APC/FC
04=1566-1606 nm L-band EA-EUI-91=APC/SC
EA-EUI-95=APC/E-2000
IQS-24XXBLD-XX-XX-XX
Specified wave length (nm):
96=1528.77 29=1554.94 62=1582.02
97=1529.55 30=1555.75 63=1582.85
98=1530.33 31=1556.55 64=1583.69
99=1531.12 32=1557.36 65=1584.53
00=1531.90 33=1558.17 66=1585.36
01=1532.68 34=1558.98 67=1586.20
02=1533.47 35=1559.79 68=1587.04
03=1534.25 36=1560.61 69=1587.88
04=1535.04 37=1561.42 70=1588.73
05=1535.82 38=1562.23 71=1589.57
06=1536.61 39=1563.05 72=1590.41
07=1537.40 40=1563.86 73=1591.26
08=1538.19 41=1564.68 74=1592.10
09=1538.98 42=1565.50 75=1592.95
10=1539.77 43=1566.31 76=1593.79
11=1540.56 44=1567.13 77=1594.64
12=1541.35 45=1567.95 78=1595.49
13=1542.14 46=1568.77 79=1596.34
14=1542.94 47=1569.59 80=1597.19
15=1543.73 48=1570.43 81=1598.04
16=1544.53 49=1571.24 82=1598.89
17=1545.32 50=1572.06 83=1599.75
18=1546.12 51=1572.89 84=1600.60
19=1546.92 52=1573.71 85=1601.46
20=1547.72 53=1574.54 86=1602.31
21=1548.51 54=1575.37 87=1603.17
22=1549.32 55=1576.20 88=1604.03
23=1550.12 56=1577.03 89=1604.89
24=1550.92 57=1577.86 90=1605.74
25=1551.72 58=1578.69 CU=1308
26=1552.52 59=1579.52
27=1553.33 60=1580.35
28=1554.13 61=1581.18
Options Code
P3=user-provided DFB(s)
P4=+10 dBm
P5=+10 dBm with PMF output b
P6=+13 dBm
P7=+13 dBm with PMF output b

3. The system for the code key shipment, which satisfies requirements of its fortuitousness and privacy and allows enlarge the speed and the distance of the generation of the key in ROADM network.

The fortuitousness in the process of the key distribution can be reached by means of polarization of photon pulses in Pockels cells (horizontal/vertical polarization) or by means of phase encoding.

The privacy appears thanks to the fundamental property of quantum mechanics called indeterminism. The single photon pulse prepared in horizontal/vertical basis and diagonally measured with equal theoretical frequency may get on detector “1” or on detector “0”. The choice is totally accidental; there is nothing in the photon that can reveal which direction it is going to take.

The privacy is reached at the expense of application of the two types of polarization. Not only of horizontal/vertical, but also diagonal polarization, which is obtained at the expense of the shift of the reference axes of the impulse x, y, z at 45 degrees, i.e. at the expense of the shift of the pole from horizontal/vertical to diagonal in order to get the second basis and may be reached by use Jones Matrix Eigenanalysis (JME) method and Method Fixed Analyzer (MFA).

The privacy is also obtained at the expense of phase shift: 0, p-cardinal basis for encoding 1 and 0 accordingly, p/2, 3p/2—basis with phase shift at p/2 for encoding 1 and 0 accordingly and may be reached by use Interferometer Generalized Method (GINTY) and Interferometer Traditional Method (TINTY) method. The given methods of testing are standardized, and successfully used today /5/.

Due to methods, mentioned above, used for measurement PMD in high-speed (up to 40 Gb/s and higher), ultra-long-haul (up to several thousand km) ROADM network, it the speed of the key generation also enlarges.

The essence of JME is the following. In order to get so-called Jones matrix when measuring Differencing Group Delay (DGD) feature they take three successive (step-by-step) measurements for a certain wavelength with free polarizations. Then they take the mean (average value) of DGD for estimation of PMD delay and PMD coefficient, or for velocities from 40 Gb/s and higher second order PMD delay, second order PMD coefficient. For this method they use a narrow-band laser source and a transmitting polarizer with scrambler and a receiving analyzer with a depolarizer.
Fixed Analyzer Method (FAM) (or Wavelength Scanning).
The essence of the method.

From the power fluctuations spectrum, the mean period of the intensity modulation is measured. This is realized by counting the number of extrema (i.e., measuring the rate at which the state of polarization changes as wavelength changes), in order to give a mean DGD. Alternatively, a Fourier transform into the time domain will also give a graph, and the RMS DGD value is determined from the standard deviation of the Gaussian curve (for fiber
links with strong mode coupling).
Interferometer Traditional Method (TINTY).
Principle of the method.

For fiber links (usually strong mode coupling), the result is an interferogram with random phases, and the mean DGD value is determined from the standard deviation of its curve. Nevertheless, the fringe envelopes obtained are a combination of two functions. An algorithm must be used to try to remove the central auto correlation peak which contains no PMD information.

Interferometer Generalized Method (GINTY).

Principle of the method.

For fiber links (usually strong mode coupling), the result is an interferogram with random phases, and the mean DGD value is determined from the standard deviation of the curve. This time, the two signals of the polarization diversity detection allow to removing the contribution of the source auto-correlation peak. It is possible to obtain the interferogram without the central peak thanks to the polarization beam splitter. However the real benefit of this method is only obtained by the use of polarization scramblers, allowing to improving absolute uncertainty of the measurement results.

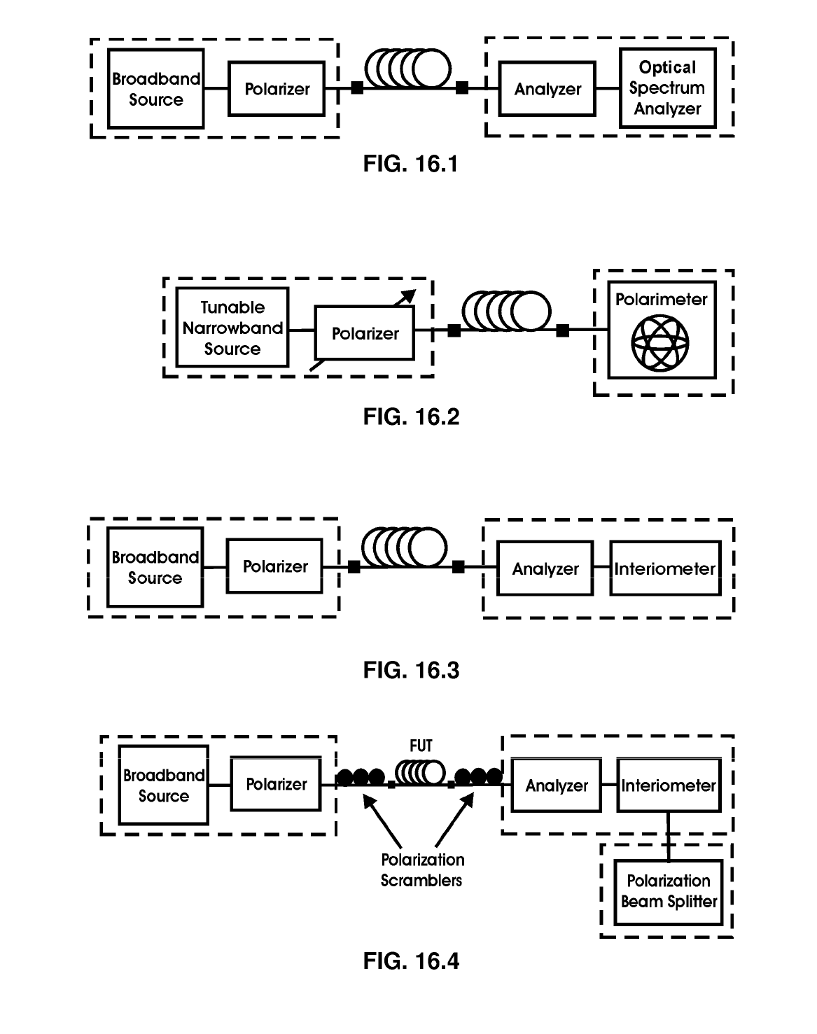

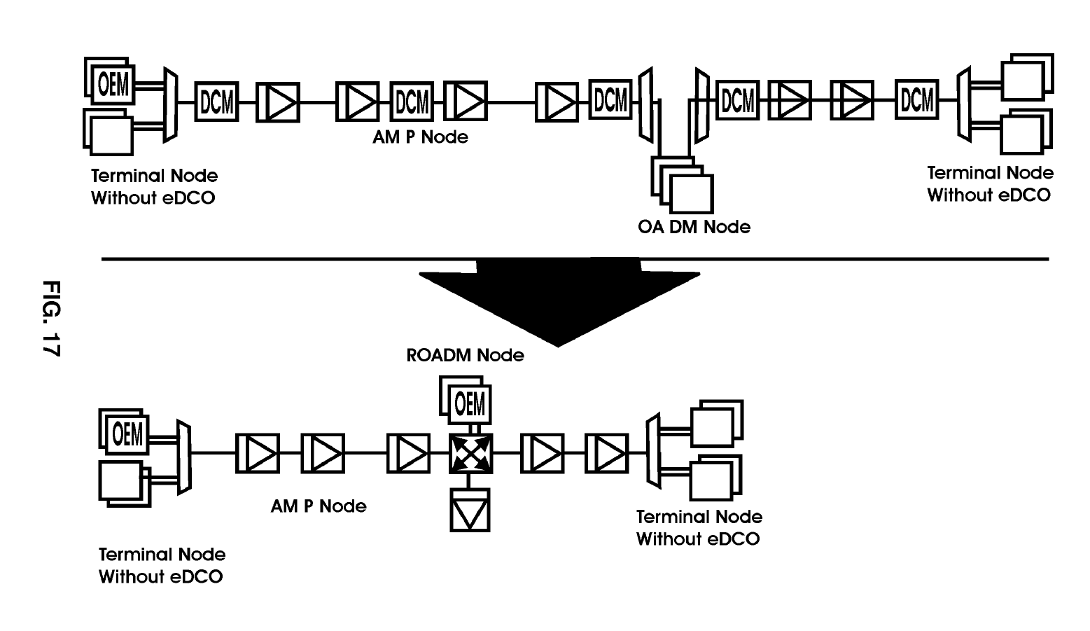

So, the schemes shown in FIG. 16 may be used for code key transmitting through ROADM based network, which satisfies requirements of its fortuitousness and privacy and allows enlarge the speed and the distance of the generation of the key in ROADM network.

Thus, the fortuitousness in the process of the key distribution can be reached by means of polarization of photon pulses in Pockels cells (horizontal/vertical polarization) or by means of phase encoding.

The privacy is reached at the expense of application of the two types of polarization (ITU G.650.2 PMD test Method—Jones Matrix Eigenanalysis JME method and Fixed Analyzer Method) and at the expense of phase shift (ITU G.650.2 PMD test Method—Interferometer Generalized Method (GINTY) and Interferometer Traditional Method).

Due to methods, mentioned above, used for measurement PMD in high-speed (up to 40 Gb/s and higher), ultra-long-haul (up to several thousand km) ROADM network, it the speed of the key generation also enlarges.

4. The achievement of the acceptable optical fiber amplification without losing its behavior and the determination of the protocol, which allow to detect and correct bit errors in fiber optic cable and ROADM network, caused by linear (attenuation, noise, dispersion) and nonlinear (four wave mixing, self phase modulation, cross phase modulation) effects.

For quantum communication we cannot use the same repeating amplifiers (repeaters) as for classic digital technique. In order to construct EPR-correlations it is necessary to transmit single Q-bit, but they cannot be amplified./9/. All that it is possible to do in this case is to register (to record) if the photon has been absorbed and if it has, then to repeat the transmitting. To this effect they use an embedded purifying protocol (cell relay), described in details in the /10/. The work of this protocol (cell relay) is used as basis for the idea of realization of the quantum repeater, which is not a local amplifier, but includes control points (checkpoints) and the embedded purifying protocol (cell relay). In the checkpoints they use a small “quantum processor” for purifying cell relay entangling and for exchange of the entangling (entanglement). The high quality tangling distribution (allocation) through a compound optical channel is coordinated by the global (embedded) purifying cell relay. This kind of network is insensitive to errors and checking at local operations.

Contemporary high-speed optical networks are developed in the direction of increasing of the signal transmission range, increasing of the possible amount of wavelengths at the expense of reducing of the channel burst between them and by simplification of the optical network structure. The result of this evolution is so-called Adaptive All Optical Intelligent Network.
Adaptive—an optical network should be easily rearrangeable (tunable) subject to the end users' acquisition.
All Optical—a network with a light amount of OEO (Optical-Electrical-Optical) conditionings (transformations).
Intelligent—a full-featured network with monitoring capabilities and automatic control of optical medium dispersion alterations for complete signal restoration (extraction).

Adaptive All Optical Intelligent Network consists of the following main component blocks or modules:

4.1. ROADM—should make it possible to Add, to Drop and to change the route of every wavelength from DWDM spectrum. It should not only ensure operation (functioning) with channel burst of 100 GHz (45 wavelengths in C-latitude, 70 wavelengths in L-latitude), but also with channel burst of 50 GHz (90 wavelengths in C-latitude, 140 wavelengths in L-latitude). It should be transport for any kind of client traffic (calls flow capacity) at speeds of 10 Gb/s, 40 Gb/s, 100 Gb/s. It should have a total compatibility with the existing DWDM systems, despite the limitations of CD, PMD, and OSNR. It is also necessary to notice that the technology used in ROADM networks—Optical Transport Network (OTN—G.709)—allows it to avoid apparent imperfections (drawbacks), inherent in Time Division Multiplexing (TDM) technologies at speed step-up, for example from 10 up to 40 Gb/s and accordingly at pulse separation reduction from 100 ps to 25 ps, viz: OSNR decrease by 6 dB, the tolerance and PMD become worse in 16 and 4 times accordingly.

4.2. Electronic Dispersion Compensation module (eDCO) is used in order to simplify the scheme of organization and reduction of the cost of photonic lines at the expense of reduction of the number of the modules Dispersion Compensation Modules (DCM). The use of Digital Signal Processing (DSP) in terminal equipment proved to be a very successful solution to how to simplify the scheme of organization of the photonic lines. In 2005 Nortel Company set forth the electronic Dynamically Compensating 10G Optic technology, which made it possible to spread the optical length over 1 242.74 miles (2000 km) without using DCM amplifiers, associated with them. It also automatically realized all the compensations (balances) in the span consisting of different fiber-optic cables, at the expense of using DSP in terminal equipment transmitters. This resulted in the absence of the necessity of re-engineering when changing over to higher velocities in fiber and in the absence of making up complicated dispersion charts (maps). Refer to FIG. 17—The simplification of optical network construction using eDCO and ROADM.

Thus, the Electronic Dispersion Compensation module (eDCO) and ROADM node can be considered as a small “quantum processor” for performing the protocol of purifying of tangling and for exchanging of tangling which allow to get acceptable optical fiber amplification without losing its behavior.

4.3. The tunable narrow-band lasers, filters Fiber Bragg Grating (FBG) and amplifiers (EDFA, OAM-Optical Amplifier Module, Raman amplifier) enabling scaling of the optical traffic network. For example, reorganization of the existing 10 Gb/s network and 40 Gb/s network.

4.4. The protocols, which allow to detect and correct bit errors in fiber optic cable, caused by linear (attenuation, noise, dispersion) and nonlinear (four wave mixing, self phase modulation, cross phase modulation) effects.

FEC (Forward Error Correction) allows it to detect 16-bit and to correct 8-bit errors (in one and the same sub-row) in the fiber-optic cable, caused by linear (attenuation, noise, dispersion) and non-linear (four wave mixing, self phase modulation, cross phase modulation) effects. It enlarges the optical signal transmission range by means of increase in signal-to-noise ratio OSNR at lower input signal layers and it reduces the necessity of using of Raman amplifiers. It was developed in order to be used in terminal equipment of long-haul optical systems at the speeds up to 12.5 Gb/s.

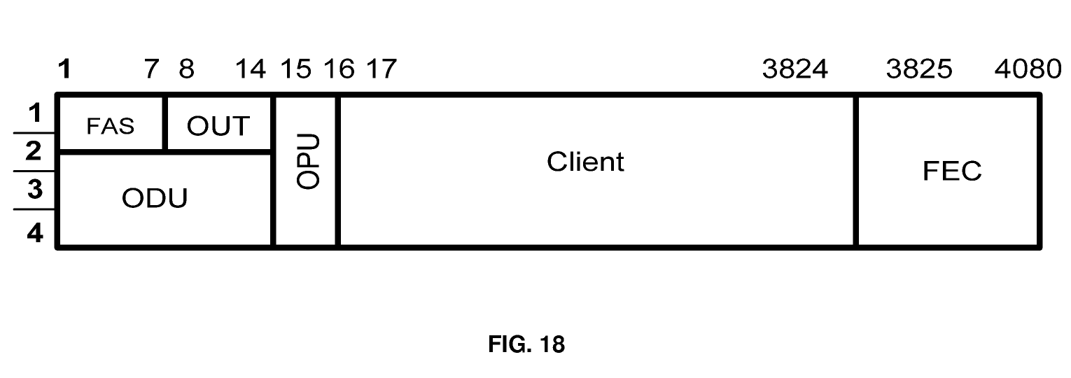

In FIG. 18 the structure of OTN (Optical Transport Network) Overhead is offered.

FAS (Frame Alignment Signal) consists of seven bytes, six of which are called a clock signal (a locking signal, sync or synchrosignal) and the seventh is MFAS (Multi Frame Alignment Signal), so called ultra frame (extra frame).

Optical Channel Transport Unit (OTU) consists of seven bytes, the first three of them are used as monitoring section, the next two are used as so called GCC 0 (General Communication Channel), serving as the starting index for terminal devices and two idle bytes (in reserve).

Optical Channel Data Unit (ODU) includes the second, third and fourth rows 14 bytes each. The detailed description of each byte's function can be found in the guidance (guidelines) G.709. The main purpose for this caption (title) is end-to-end supervision support and client adaptation support—the bytes of TCM (Tandem Connection Monitoring), PM (Path Monitoring).

Optical Payload Unit (OPU) serves the purpose of identification of the embedded client (payload type) traffic.

Client is the client traffic, embedded into the structure OTN-SDH, GFP, IP, GbE.

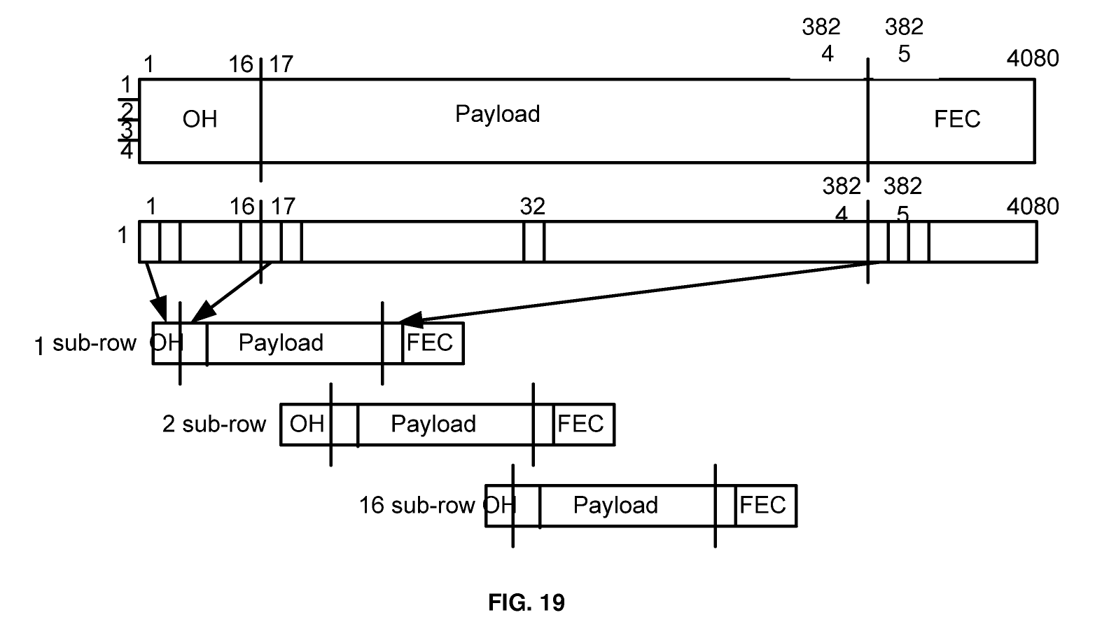

FEC—Forward Error Correction consists of four rows 255 byte each and it uses Reed Solomon code, the principle of operation of which is described below. Refer to FIG. 19.

RS (255,239) code provides net electrical coding gain (NECG) 6.3 dB with 1E-15 corrected bit-error rate (BER) and today it is used in the majority of long-haul fiber transmissions.

OTN is divided into 16 sub-rows 255 bytes each.

Each sub-row is formed by means of addition one byte from OH, Payload and FEC to Payload.

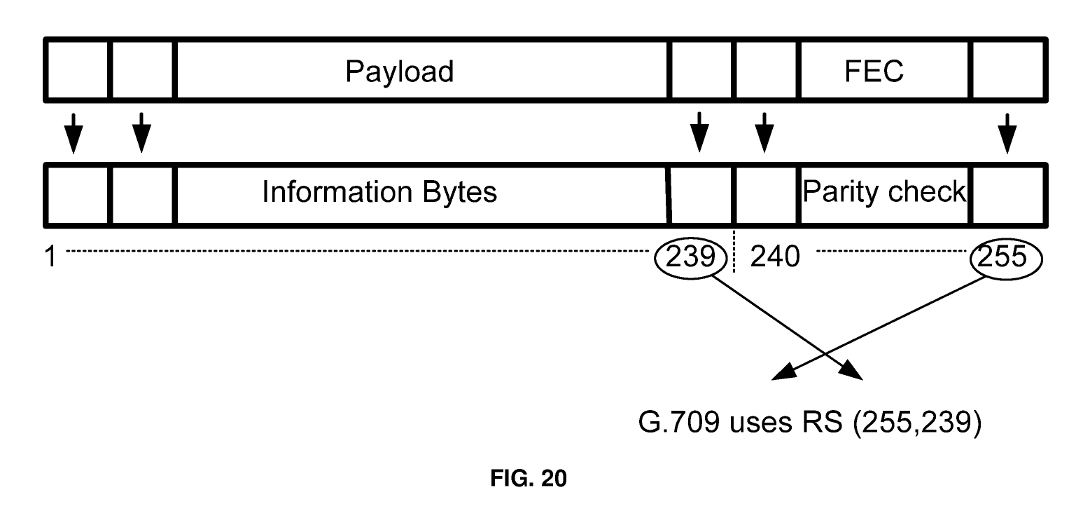

In FIG. 20 you can see Reed Solomon code algorithm.

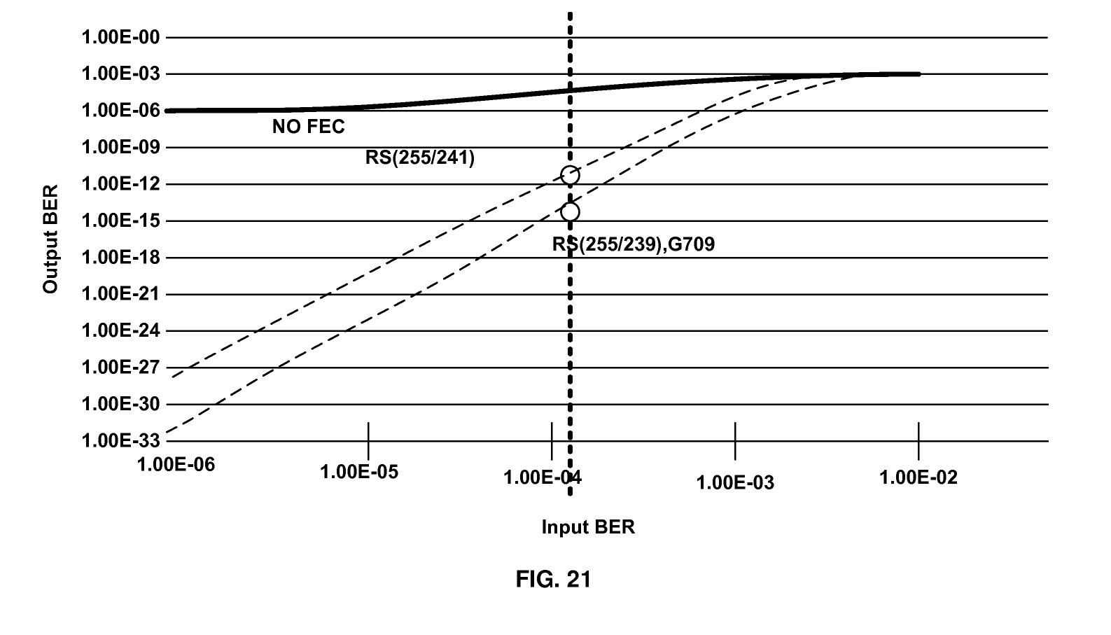

After that, 239 information bytes from each sub-row are used in order to count FEC Parity Check sum, consisting of 8 bits. This is so called codeword. The result of this calculation is transferred for the first sub-row in the 240^{th} byte, for the second sub-row in the 241^{st} byte, for the 16^{th} sub-row in the 255^{th} byte. The larger is the codeword, which is in this case 8-bits order, the more inaccurate received bits can be corrected. FEC RS (255,239) is used for standardized Ingress Inter Domain Interface and it also allows it to reduce the number of complex 3R (Re amplify-Reshape-Retime) devices. The application of FEC RS (255,239) allows it to work with very low layers of optical signals, refer to FIG. 6 (BER—Bit Error Rate Performance), and at the same time it makes it possible to correct the potential errors. As it can be seen in FIG. 21, when the input optical signal has the quality of 1.00E-06 of bit errors and it uses RS (255,239) G.709 in order to correct them, then the quality of the output signal is not worse than 1.00E-32 bit errors.

Advanced FEC is developed to be used in terminal equipment of ultra-long-haul (ULH) optical systems, next generation extreme-long-haul (ELH) optical systems at speeds up to 12.5 Gb/s.

The increase of the number of channels of DWDM systems caused the necessity of creating algorithms for correcting the value net electrical coding gain (NECG) for bit errors less than 1E-15 and as a result it caused the necessity of application of additional codes, such as Bose-Chaudhuri-Hocquenguem (BCH). The idea of application of so called associated (bound) codes expects that it is necessary to meet condition k/n, where k is the dimension of the codeword, n is the size of data block inside the codeword. Hamming distance is calculated just by multiplication of ko/no*ki/ni ratios for subcode (inner code) and external code. And the more it is the more is the code redundancy and accordingly the more is its correcting ability. In the diagram Advanced FEC the combination of the sub code and the external code (two-dimensional correction or adjustment) increases Hamming distance, meanwhile the sub code operates with extremely high indices of bit errors, and the external code—with low indices of bit errors, but with a very high index of burst-error tolerance, i.e. it has the opportunity of correcting of bit errors, flowing in packs (bursts). The technology of so called multi dimensional correction or turbo-coding is a scheme that allows it to correct different types of errors as a result of several successive operations, but not as a result of only two operations as it is in the case of two-dimensional correction. So, for additional correction of low layer errors, from 1E-15 and lower, they use more complex code combinations than Reed Solomon (239,255), which is used in FEC protocol. Besides, Advanced FEC allows it more effectively to suppress non-linear aberrations in the optical channel (four wave mixing, self phase modulation, cross phase modulation), which are the main factor of degradation of signal-to-noise ratio OSNR. That is why if the NECG index improves just by 1 dB it makes it possible to increase the optical signal transmission range by 12% and with acceptable quality of OSNR. Today the extent of optical lines, which use Advanced FEC algorithm amounts to 5000 km.

For safe delivery of quantum confidential keys through ROADM network logic 0 and 1 should be transferred by sequences of the conditions, allowing correct bit errors in an optical cable.

Altogether, FEC protocols and Advanced FEC protocols may be approached as global (embedded) protocols of purifying for splitting of high quality entangling over the compound optical channel.

5. For high transmission speeds (40 Gb/s and higher) it is necessary to examine in addition the usage of optical signal encryption and modulation for dispersion losses compensation (PMD, CD).

In order to achieve high speeds of optical signal transmission (from 40 Gb/s and higher) the equipment manufacturers suggest using of the following types of modulations for dispersion losses compensations:
Duobinary;
Differential Phase Shift Keying (DPSK);
Differential Quadrature Phase Shift Keying (DQPSK).

Duobinary modulation changes the optical signal phase in such a way that it exactly halves the average value (mean value) of optical power of the signal for coding of the state “1” in NRZ (Non-to-Return-to-Zero) code. This allows it to reduce the optical bandwidth, to increase OSNR ratio, and of course, to improve CD and PMD value.

Differential Phase Shift Keying (DPSK) uses that type of modulation, which causes the application of so called balanced detectors (p-i-n diodes) and it is a more expensive technology for equipment realization, than Duobinary modulation. However, DPSK modulation gives the sensitivity level of OSNR 3 dB higher than Duobinary modulation does.

Differential Quadrature Phase Shift Keying (DQPSK) is, strictly speaking, a four-layer version of DPSK, in which each symbol (sign, character) is encoded by means of combinations 00, 01, 11, 10. And so, the pass band of the optical signal is halved compared to DPSK modulation. In this case, the cost of optical receivers increases at the expense of complication of optoelectronic components and at the expense of the increase in the number of so called one-bit optical delay circuits.

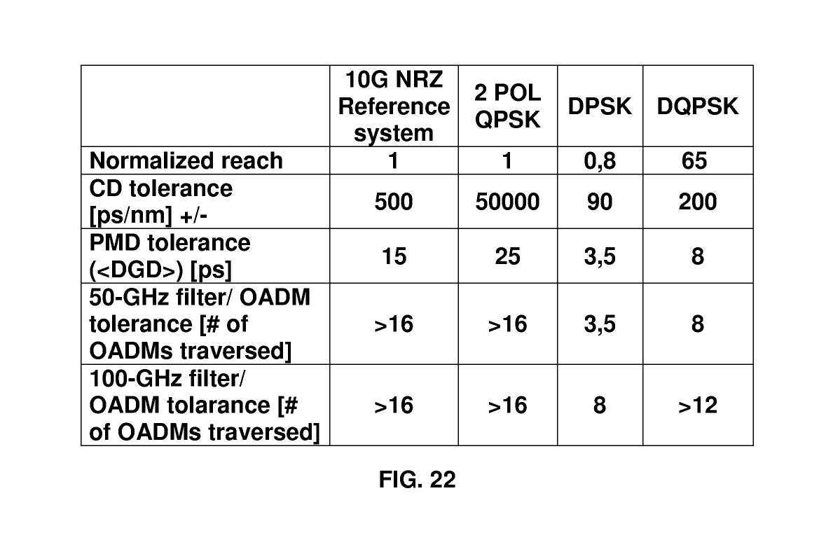

The comparative description of different types of modulations is given in FIG. 22.

In the first row the maximal length of the optical spacing with the use of different types of modulations is taken as a departing point. Thus, for Duobinary modulation the length of the optical spacing without reclaiming (regeneration) and using Raman amplifiers amounts to about 310.69 miles (500 km), accordingly, without using this type of modulation (for Reference system) it is four times less.

In the second and third rows there are depicted the least allowable PMD, CD values for the chosen types of modulations of the optical signal.

In the two lower rows it is shown which is the maximum allowable number of ROADM devices (WSS, WXC, PLC, WB, EDFA, OAM, Raman amplifier, e.g.) for use in one spacing of optical network, without obligatory reclaiming of the signal for different channel bursts (intervals) between neighbor wavelengths—50 GHz and 100 GHz.

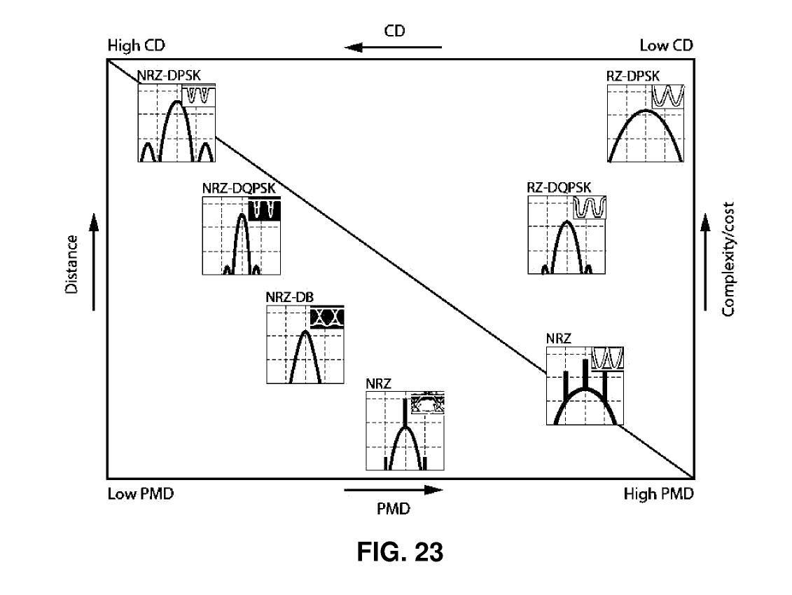

If try to use a comprehensive (complex, integrated) approach to determination of the types of modulation which is necessary to be used for compensation (balance) of dispersion losses as the function (feature) of distance (Distance) and complexity of realization of the optical circuits (Complexity/cost) then it is possible to refer to the table, depicted in FIG. 23.

From the chart, depicted in FIG. 23, it is obvious that in order to solve the problems on compensation of dispersion losses communication statements should apply different types of modulations, described above. The codes of optical signal (NRZ, RZ) also depend on the length of the haul and on the cost of the equipment, forming it.

If we want to increase the maximum allowable number of ROADM devices (WSS, WXC, PLC, WB, EDFA, OAM, Raman amplifier, e.g.) for use in one spacing of optical network, without obligatory reclaiming of the signal for different channel intervals between neighbor wavelengths—50 GHz and 100 GHz, we can use 2 POL QPSK modulation by Nortel (see FIG. 22).

Evidently, it is better to use 2-POL QPSK modulation, that allow to increase amount of ROADM devices (WSS, WXC, PLC, WB, EDFA, OAM, Raman amplifier, e.g.) to 16 and higher compare to other types of modulation and increase distance fiber optic systems at high speed (40 Gb/s, 100 Gb/s) to several thousand km.

6.The development of quantum encoding systems for widespread telecommunications network topologies, such as point-to-point, point-to-multipoint, star, ring, adjacent rings and for use in ROADM network. Today, in addition to the topologies point-to-point and point-to-multipoint, (for example, the central office of a bank—its branches), some improvement in that direction has been suggested already, but may be it still needs deeper investigations. Some examples of the improvement can be found in /11/.

Recent investigations in area of network topologies, that can be use for quantum encoder, one should take in the next references /6, 7, 8/.

Next ITU-T, IEEE and RFC Recommendation can be use for quantum encoder. in ROADM network:
Resilient Packet Ring (RPR), also known as IEEE 802.17;
ERPS (Ethernet Rings Protection Switching). This is defined in ITU-T G.8032;
Spatial Reuse Protocol (RFC2982);
Dynamic Packet Transport;
Open Transport Network;
Metro Ring Protocol.

The switchover mechanism is hardware based and results in ultra fast (50 ms) switchover without service loss. For this purposes we can use next protocols:

6.1. Resilient Packet Ring (RPR), also known as IEEE 802.17, is a standard designed for the optimized transport of data traffic over optical fiber ring networks. Its design is to provide the resilience found in SONET/SDH networks (50 ms protection) but instead of setting up circuit oriented connections, providing a packet based transmission. This is to increase the efficiency of Ethernet and IP services. RPR works on a concept of dual counter rotating rings called ringlets. These ringlets are set up by creating RPR stations at nodes where traffic is supposed to drop, per flow (a flow is the ingress and egress of data traffic). RPR uses MAC (Media Access Control protocol) messages to direct the traffic, which can use either ringlet of the ring. The nodes also negotiate for bandwidth among themselves using fairness algorithms, avoiding congestion and failed spans. The avoidance of failed spans is accomplished by using one of two techniques known as “steering” and “wrapping”. Under steering if a node or span is broken all nodes are notified of a topology change and they reroute their traffic. In wrapping the traffic is looped back at the last node prior to the break and routed to the destination station. All traffic on the ring is assigned a Class of Service (CoS) and the standard specifies three classes. Class A (or High) traffic is a pure CIR (Committed Information Rate) and is designed to support applications requiring low latency and jitter, such as voice and video. Class B (or Medium) traffic is a mix of both a CIR and an EIR (Excess Information Rate—which is subject to fairness queuing). Class C (or Low) is best effort traffic, utilizing whatever bandwidth is available. This is primarily used to support Internet access traffic. Another concept within RPR is what is known as “spatial reuse”. Because RPR “strips” the signal once it reaches the destination (unlike a SONET UPSR/SDH SNCP ring, in which the bandwidth is consumed around the entire ring) it can reuse the freed space to carry additional traffic. The RPR standard also supports the use of learning bridges (IEEE 802.1D) to further enhance efficiency in point to multipoint applications and VLAN tagging (IEEE 802.1Q). One drawback of the first version of RPR was that it didn't provide spatial reuse for frame transmission to/from MAC addresses not present in the ring topology. This was addressed by IEEE 802.17b, which defines an optional Spatially aware sub layer (SAS). This allows spatial reuse for frame transmission to/from MAC address not present in the ring topology.

6.2. ERPS (Ethernet Rings Protection Switching). Ethernet Rings Protection Switching or ERPS is an effort at ITU-T to provide sub-50 ms protection for Ethernet traffic in a ring topology and at the same time ensuring that there is no loops formed at the Ethernet layer. This is defined in ITU-T G.8032. The first version supported a single ring architecture and the second version is expected to address multiple rings.

Principle of Operation

In ERPS there is a central node called RPL owner node which blocks one of the port to ensure that there is no loop formed for the Ethernet traffic. The link which gets blocked by the RPL is called Ring Protection Link or RPL. The other node which is connected to the RPL is known as just RPL node. It uses messages called R-APS to coordinate the activities of switching on/off the RPL link. Any failure along the ring triggers a R-APS (SF) [R-APS (Signal Fail)] message along both the direction from the nodes adjacent to the failed link after these nodes have blocked the port facing the failed link. On obtaining this message, RPL owner unblocks the RPL port. (Note here that as there is at least one link which has failed somewhere in the ring ensures that there can be no loop formation in the ring.)During the recovery phase when the failed link gets restored the nodes adjacent to the restored link send R-APS(NR) [R-APS (No Request)] messages. On obtaining this the RPL owner block the RPL port and then send R-APS(NR,RB) [R-APS(NR, Root blocked)] messages. This will cause all other nodes other than RPL owner in the ring to unblock all the blocked ports. This protocol is robust enough to work for unidirectional failure and in case of multiple failures in the ring. It allows mechanism to Force Switch (FS) or Manual Switch (MS) to take care of field maintenance scenario.

6.3. Spatial Reuse Protocol (RFC2982).

Spatial Reuse Protocol is a networking protocol developed by Cisco Systems. It is a MAC-layer (sub layer of layer 2) protocol for ring-based packet internetworking that is commonly used in optical fiber ring networks. Ideas from the protocol are reflected in parts of the IEEE 802.17 Resilient Packet Ring (RPR) standard.

SRP was first developed as a layer 2 (data-link layer) protocol to link Cisco's Dynamic Packet Transport (DPT) protocol (a method of delivering packet-based traffic over a SONET/SDH infrastructure) to the physical SONET/SDH layer. DPT cannot communicate directly with the physical layer, therefore it was necessary to develop an intermediate layer between DPT and SONET/SDH, SRP filled this role.

Analogy to POS.

SRP behaves quite like the Point-to-Point Protocol (PPP) does in a Packet Over SONET (POS) environment. PPP acts as an abstraction layer between a higher level layer 2 technology such as POS and a layer 1 technology such as SONET/SDH. Layer 1 and high level layer 2 protocols cannot interact directly without having an intermediate low level layer 2 protocol, in the case of DPT the layer 2 protocol is SRP.

Spatial Reuse Capability

DPT environments contain dual, counter-rotating rings, somewhat like FDDI. SRP has a unique bandwidth efficiency mechanism which allows multiple nodes on the ring to utilize the entirety of its bandwidth, this mechanism is called the Spatial Reuse Capability. Nodes in an SRP environment can send data directly from source to destination. Consider the following ring environment (for example, running at OC-48c [2.5 Gbit/s]) with 6 routers (A through F sequentially) on it. Routers A and D are sending data back and forth at 1.5 Gbit/s while routers B and C are sending data at 1 Gbit/s, this utilizes the entire 2.5 Gbit/s across routers A through D but still leaves routers F and E untouched. This means that routers F and E can be sending data at 2.5 Gbit/s between each other concurrently, resulting in the total throughput of the ring being 5 Gbit/s. The reason for this is the implementation of a method called “destination stripping”. Destination stripping means that the destination of the data removes it from the ring network, this differs from “source stripping” in that the data is only present on the section of network between the source and destination nodes. In source stripping, the data is present all the way around the ring and is removed by the source node. FDDI and token ring networks use source stripping, whereas DPT and SRP use destination stripping. Again, consider the previous example of the OC-48c ring. In a source stripping (FDDI or Token Ring) environment, in the event that router A wanted to communicate with router D, the entire network would be taken up while the data was being transmitted because it would have to wait until it completed the loop and got back to router A before it was eliminated. In a destination stripping (DPT and SRP) environment, the data would only be present between router A and Router D and the rest of the network would be free to communicate.

SRP Header

The SRP header is 16 bits (2 bytes) total. It contains 5 fields. These fields are as follows: Time to Live (TTL), Ring Identifier (R), Priority (PRI), Mode, and Parity (P). The TTL field is 8 bits, its only metric is hop count. The R field is 1 bit (either 0 or 1 designating the inner or outer ring). The PRI field is 3 bits designating the packet priority. The Mode field is 3 bits designating what type of data is contained in the payload. The P field is 1 bit.

6.4. Dynamic Packet Transport

Dynamic packet transport (DPT) is a Cisco transport protocol designed for use in optical fiber ring networks. In overview, it is quite similar to POS and DTM. It was one of the major influences on the Resilient Packet Ring/802.17 standard.

Protocol Design

DPT is implemented as two counter-rotating rings. This means the network is composed of two completely separate rings of fiber that are both able to transmit data concurrently. This design provides for redundancy in case of a fiber cut or link failure, and increased throughput in common situations. DPT as opposed to POS or normal SONET/SDH is able to use both rings at the same time whereas POS only uses one ring under normal circumstances but switches to the second upon failure of the first. Cisco claims that DPT can run with double the bit-rate of POS due to this characteristic. Another interesting point is the fact that DPT is not a PPP whereas POS is. This means that traffic between two nodes of a DPT ring does not affect intermediate nodes. With the introduction of DPT came the introduction of another Cisco developed MAC layer protocol, Spatial Reuse Protocol or SRP. The use of SRP in conjunction with DPT makes it possible for DPT to communicate with the physical layer.

Types of Data in DPT Networks

As with most other lower layer protocols, there are methods for communicating not only application data between the nodes of a DPT network. It is necessary for the nodes to be able to communicate control data between each other in case of a fiber cut or link failure so the nodes can forward traffic on the appropriate interfaces and maintain network connectivity. Both control packets, and data packets are transmitted on both rings in order to maintain connectivity and full bandwidth utilization in normal situations; but once a failure occurs, the control data will notify the applicable routers of the failure and all the routers will switch to using only their active interfaces for data and control packets.

DPT Packet Structure

The structure of a DPT Packet is quite similar to that of Ethernet. It contains a source and destination MAC address (both 48-bits long), a protocol type identifier (used for identifying the upper layer protocol contained in the payload), and an FCS used to validate the data.

DPT Topologies

Both DPT and SRP are independent of their physical layers. This means that the DPT protocol can operate above several physical mediums such as SONET/SDH, Gigabit Ethernet, and others. As aforementioned, DPT is composed of two rings for fault tolerance and increased throughput. The method for switching between these two rings in the event of a failure is called Intelligent Protection Switching, or IPS. This ensures that a fiber cut or link failure (layer 1 error) will be rectified and IP traffic will be resumed within 50 ms. DPT also contains a “plug and play” feature which dynamically fetches the MAC addresses of neighboring devices which provides for very simple configuration with little to no setup prior to functional data transfer.

6.5. Open Transport Network.

OTN, which stands for Open Transport Network is Siemens Atea's flexible private communication network, based on the fiber optic technology. It is a brand name and not to be mistaken with Optical Transport Network. It is a networking technology that aims at transporting a number of communication protocols over an optical fiber and is a mix of Transmission and Access NE. This includes serial protocols (e.g. RS232) as well as telephony (POTS/ISDN), audio, Ethernet, video and video-over-IP (via M-JPEG, MPEG2/4, H.264 or DVB).

The basic building block of OTN is called a node. It is a 19″ frame that houses and interconnects the building blocks that produce the OTN functionality. Core building blocks are the power supply and the optical ring adapter (called BORA: Broadband Optical Ring Adapter). The remaining node space can be configured with up to 8 (different) layer 1 interfaces as required. OTN nodes are interconnected using pluggable optical fibers in a dual counter rotating ring topology. The primary ring consists of fibers carrying data from node to node in one direction, the secondary ring runs parallel with the primary ring but carries data in the opposite direction. Under normal circumstances, only one ring carries active data. If a failure is detected in this data path, the secondary ring is activated. This hot standby topology results in a 1+1 path redundancy. The switchover mechanism is hardware based and results in ultra fast (50 ms) switchover without service loss.

Virtual bidirectional point-to-point or point-to-multipoint connections (services) between identical interfaces in different nodes are programmed via a configuration software called OMS (OTN management system). By doing this, OTN mimics a physical wire harness interconnecting electronic data equipment but with the added advantages typical for fiber transmission and with high reliability due to the intrinsic redundant concept.

This concept makes the Open Transport Network the de-facto transmission backbone standard for industrial high reliability communication sites that require error free communication for a large spectrum of protocols over long distances like pipelines, metros, rail, motorways and industrial sites.

The optical rings transport frames with a bit rate of (approximately) 150 Mb/s (STM-1/OC-3), 622 Mb/s (STM-4/OC-12), 2.5 Gb/s (STM-16/OC-48) or 10 Gb/s (STM-64/OC-192). The frames are divided into 32 kb payload cells that carry the service data from source to destination. Via the OTN management system, as many cells as required by the service are allocated to connections. This bandwidth allocation is transferred to the non-volatile memory of the control boards of the nodes. As a result, the network is able to start up and work without the OMS connected or on line.

6.6. Metro Ring Protocol.

The Metro Ring Protocol (MRP) is a Layer 2 resilience protocol developed by Foundry Networks and currently being delivered in products manufactured by Foundry and Hewlett Packard. The protocol quite tightly specifies a topology in which layer 2 devices, usually at the core of a larger network, are configured and as such is able to achieve much faster failover times than other Layer 2 protocols such as Spanning Tree.

On the basis of what has been said above, one can assume, that proposed by the present invention quantum cryptography methods seem to be completely realizable from the technical viewpoint for long haul and extreme long haul distance fiber optic DWDM systems with high speed transmission 10,40,100 Gb/s for commercial proposals.

### BIBLIOGRAPHY

1. D. Deutsch, A. Ekert, R. Jozsa, C. Macchiavello, S. Popescu, A. Sanpera Phys. Rev. Lett. 77, 2818. (1996).

2. C. Macchiavello, Phys. Lett. A 246, 385 (1998).

3. Man-Hong Cheung, “PMD-insensitive OSNR monitoring based on polarization-nulling with off-center narrowband filtering”, IEEE Photon. Technol. Lett., vol. 16, No. 11 November 2004

4. W. Moench, J. Larikova, “In-service measurements of the OSNR in ROADM-based Networks”, ECOC 2007 P118.

5. ITU G.650.2 PMD test Methods—Jones Matrix Eigenanalysis (JME) Fixed Analyzer Method, Interferometer Generalized Method (GINTY) and Interferometer Traditional Method (TINTY).

6. Groth, David; Toby Skandier (2005). Network+Study Guide, Fourth Edition'. Sybex, Inc. ISBN 0-7821-4406-3.

7. ATIS committee PRQC. “network topology”. ATIS Telecom Glossary 2007. Alliance for Telecommunications Industry Solutions. Retrieved on Oct. 10, 2008.

8. Sheldon, Tom (2006). “Token Bus Network”. Linktionary.com. Retrieved on Oct. 10, 2008.

9. W. K. Wooters and W. H. Zurek, Nature, London (1982), R. J. Glauber, In Frontiers in Quantum Optics, 534, Adam Hilger, Bristol (1986)

10. H. J. Briegel, W. Dur, J. I. Cirac, P. Zoller Phys. Rev. Lett. 81, 5932 (1998)

11. P. D. Townsend, Nature, (1997)

I claim:

1. A method of the private key transmitting and measurement on Reconfigurable Optical Add Drop Multiplexers (ROADM) based networks for Einstein-Podolsky-Rozen (EPR) polarized photons with single photon source comprising:
performance of private key extraction in ROADM networks along with realization of the Quantum Protection Amplification (QPA) scheme for the purpose to clean states of the entangling polarized photons in a presence of noise in optical channels;
performance the method of the code key shipment, which meets requirements of fortuitousness and privacy and allows enlarge the speed and the distance of the generation of the key in ROADM network;
performing bit errors rate (BER) correction in fiber optic cable, caused by linear—as attenuation, noise, dispersion, and nonlinear—as four wave mixing, self phase modulation, cross phase modulation, effects;
selection of modulation mode for high speed data service on the level of 40 Gb/s or higher, for polarization mode dispersion (PMD) and chromatic dispersion (CD) compensation;
selection of one of the following protocols as Resilient Packet Ring (RPR), also known as IEEE 802.17 or ERPS (Ethernet Rings Protection Switching(ITU-T G.8032 for widespread telecommunications network topologies of the following types—point-to-point, point-to-multipoint, star, ring, adjacent rings—with ultra fast switchover mechanism to avoid service loss.

2. Device for realization of quantum encoding method on dense wavelength division multiplexing (DWDM) network for EPR polarized photons with single photon source as recited in claim 1, comprising:
means for private key extraction in the presence of cable noise in fiber optics in ROADM based networks and with the use of QPA scheme, based on dual ports Optical Spectrum Analyzer (OSA) with embedded Optical Polarized Splitter (OPS) method;
device for emanation of ERP polarized photons-single photon laser source;
device for code key shipment, which satisfies requirements of fortuitousness, privacy and allows enlarge the speed and the distance of the generation of the key in ROADM network comprising depend of used methods (JME, Fixed Analyzer Method, GINTY or TINTY)—narrow or broadband laser source, polarizer, scrambler, polarimeter, polarization beam splitter, interferometer, optical spectrum analyzer;
quantum repeater for bit errors detection and correction in fiber optic cable, caused by linear—as attenuation, noise, dispersion-PMD, CD, and nonlinear—as four wave mixing, self phase modulation, cross phase modulation, effects;
device for modulation signal high speed, of 40 Gb/s or higher, data service for the polarization mode dispersion (PMD) and chromatic dispersion (CD) compensation;
device of switchover mechanism type for widespread telecommunications network topologies, as point-to-point, point-to-multipoint, star, ring, adjacent rings for the purpose ultra fast switchover to avoid service interruption.

3. Method as recited in claim 1, where the said private key extraction in the presence of cable noise in fiber optics and ROADM based networks and realization of the QPA scheme to clean structure of the entangling polarized photons comprising:
selecting mode for single-photon emanation in accordance with demands of by a stable power testing of predefined high-accuracy with power stability during 15 min ±0.005 (dB) (Δ=0.01) and during 8 hours ±0.03 (dB) (Δ=0.06), output power uncertainty (dB) ±0.3, of spectral sensitivity with wavelength accuracy (nm) ±0.01 and wavelength stability (nm) ±0.002;
transmitting secret keys through ROADM network at certain wavelength from DWDM range;
performing of the code key shipment, satisfying requirements of fortuitousness, privacy and allows enlarge the speed and the distance of the generation of the key in ROADM network,
said fortuitousness in the process of the key distribution is to be reached by means of polarization of photon pulses in Pockets cells (horizontal/vertical polarization) or by means of phase encoding;
said privacy is to be reached using two types of polarization;
two types of polarization regarding ITU G.650.2 PMD test Methods—Jones Matrix Eigenanalysis JME method and Method Fixed Analyzer, and
phase shift regarding ITU G.650.2 PMD test Methods
Interferometer Generalized Method (GINTY) and Interferometry Traditional Method (TINTY)),
said increase of the speed and the distance of the generation of the key is to be reached using of methods for measurement PMD (JME, MFA, GINTY, TINTY) in high speed and ultra-long-haul ROADM network;
performing of bit errors detection and correction in fiber optic cable and ROADM network using Forward Error Correction (FEC) for long-haul optical systems at the speeds up to 12.5 Gb/s or Advanced FEC (AFEC) in the case of terminal equipment (quantum repeater) of ultra-long-haul (ULH) optical systems or extreme-long-haul (ELH) optical systems at speeds up to 12.5 Gb/s;
performing modulation for high speed data service of 40 Gb/s and higher, for the compensation of polarization mode dispersion (PMD) and chromatic dispersion (CD);
performing protection of one of the following telecommunications network topologies in ROADM networks from service interruption, such as point-to-point, point-to-multipoint, star, ring, adjacent rings by means with embedded switchover mechanism, that use Resilient Packet Ring (RPR), also known as IEEE 802.17 or ERPS (Ethernet Rings Protection Switching(ITU-T G.8032);
receiving secret keys from ROADM network at certain wavelength from DWDM range, said DWDM range at identical wavelength as transmit;
private keys extraction at receiving side by QPA scheme based on dual port Optical Spectrum Analyzer (OSA) with embedded OPS method;
measuring by means dual port OSA the in-band OSNR (Optical Signal-to-Noise Ratio) using Optical Polarization Splitter (OPS) method, which based on polarization-nulling technique;
performing imposition secret key, which has been extracted by QPA scheme, at the customers data in multiplexers ROADM for purpose of quantum encoding.

4. System for realization of method as recited in claim 3, comprising:
single-photon laser source that meets a requirements of high-accuracy and the stable power testing with power stability during 15 min ±0.005 (dB) (Δ=0.01) and during 8 hours ±0.03 (dB) (Δ=0.06), output power uncertainty (dB) ±0.3, of spectral sensitivity with wavelength accuracy (nm) ±0.01 and wavelength stability (nm) ±0.002;
transmitting means for transmitting secret keys through ROADM network at certain wavelength from DWDM range;
performing of the code key shipment, satisfying requirements of fortuitousness, privacy and allows enlarge the speed and the distance of the generation of the key in ROADM network comprising:
tunable narrowband laser source, three linear polarizers and polarimeter in according to ITU G.650.2 PMD test Method—Jones Matrix Eigenanalysis (JME method);
broadband polarized laser source and a polarized (variable) optical spectrum analyzer in according to ITU G.650.2 PMD test Method-Fixed Analyzer Method.
broadband laser source, polarizer, optical spectrum analyzer, interferometer (Mach-Zehnder or Michelson in according to ITU G.650.2 PMD test Method—Interferometer Traditional Method (TINTY);
broadband laser source, polarizer, two polarization scramblers, optical spectrum analyzer, interferometer (Mach-Zehnder or Michelson) polarization beam splitter in according to ITU G.650.2 PMD test Method—Interferometer Generalized Method (GINTY);
quantum repeater comprising embedded protocols, for performing of bit errors detection and correction in fiber optic cable using Forward Error Correction (FEC) with Reed Solomon (RS (255,239)) code algorithm, which allows it to detect 16-bit and to correct 8-bit errors for long-haul optical systems at the speeds up to 12.5 Gb/s and or Advanced FEC (AFEC) in the case of terminal equipment(quantum repeater) of ultra-long-haul (ULH) optical systems or extreme-long-haul (ELH) optical systems at speeds up to 12.5 Gb/s;
means as WXC (Wavelength Cross Connector), WSS (Wavelength Selective Switch) with embedded modulator 2POL QPSK or Differential Quadrature Phase Shift Keying (DQPSK) and the like for performing modulation for high speed data service (40 Gb/s and higher) and use mechanism for the compensation polarization mode dispersion (PMD) and chromatic dispersion (CD);
means with embedded switchover mechanism, as Wavelength Cross Connector (WXC), Wavelength Selective Switch (WSS), that use methods of Resilient Packet Ring (RPR) also known as IEEE 802.17 or ERPS (Ethernet Rings Protection Switching (ITU-T G.8032) and the like, for obtaining protection from service interruption of telecommunications network topologies, as point-to-point, point-to-multipoint, star, ring, adjacent rings;
receiving means for receiving secret keys from ROADM network at certain wavelength from DWDM range, said DWDM range at identical wavelength as transmit;
private key extraction means for private keys extraction at receiving side by dual port Optical Spectrum Analyzer (OSA) with embedded OPS method;
measuring means (dual port OSA) for measuring the in-band OSNR (Optical Signal-to-Noise Ratio) using Optical Polarization Splitter (OPS) method, which based on polarization-nulling technique;
multiplexer ROADM, that performs imposition secret key, extracted by QPA scheme, at the customers data for purpose of quantum encoding.

5. Device for the code key shipment as recited in claim 2, which meets requirements of fortuitousness and privacy, comprising:
tunable narrowband laser source, three linear polarizers and polarimeter in according to ITU G.650.2 PMD test Method—Jones Matrix Eigenanalysis (JME method);
broadband polarized laser source and a polarized (variable) optical spectrum analyzer in according to ITU G.650.2 PMD test Method-Fixed Analyzer Method;
broadband laser source, polarizer, optical spectrum analyzer, interferometer (Mach-Zehnder or Michelson in according to ITU G.650.2 PMD test Method—Interferometer Traditional Method (TINTY);
broadband laser source, polarizer, two polarization scramblers, optical spectrum analyzer, interferometer (Mach-Zehnder or Michelson) polarization beam splitter in according to ITU G.650.2 PMD test Method—Interferometer Generalized Method (GINTY).
